(19) United States
(12) Patent Application Publication
(10) Pub. No.: US 2022/0015355 A1
(43) Pub. Date: Jan. 20, 2022

(54) NOVEL CARRIER FLUIDS FOR LIQUID FUNGAL SPORE FORMULATIONS

(71) Applicants: Bayer Aktiengesellschaft, Leverkusen (DE); Bayer CropScience Aktiengesellschaft, Monheim am Rhein (DE)

(72) Inventors: Oliver GAERTZEN, Köln (DE); Kai TEMMING, Leverkusen (DE); Roman HEUMANN, Langenfeld (DE); Ute EIBEN, Malchow/Poel (DE); Antje SEEMAN, Boiensdorf OT Stove (DE); Ulrike HILSCHER, Wismar (DE)

(21) Appl. No.: 17/258,878

(22) PCT Filed: Jul. 10, 2019
(86) PCT No.: PCT/EP2019/068474

§ 371 Date: Jan. 8, 2021

(30) Foreign Application Priority Data
Jul. 10, 2018 (EP) 18182673.6

(51) Int. Cl. A01N 25/02; A01N 63/30; A01N 63/36

(52) U.S. Cl. CPC A01N 25/02; A01N 63/36; A01N 63/30

(57) ABSTRACT

The present invention relates to a liquid preparation comprising at least one ethoxylated and/or propoxylated organic liquid as defined and fungal spores and a method for controlling phytopathogenic fungi, insects and/or nematodes in or on a plant, for enhancing growth of a plant or for increasing plant yield or root health comprising applying an effective amount of the liquid preparation or the liquid composition according to the invention to said plant or to a locus where plants are growing or intended to be grown.

Biological control agents (BCAs) become more and more important in the area of plant protection, be it for combatting various fungal or insect pests or for improving plant health. Although also viruses are available which can be used as biological control agents, mainly BCAs based on bacteria and fungi are used in this area. The most prominent form biological control agents based on fungi are the asexual spores called conidia as well as blastospores, but also other fungal propagules may be promising agents, such as (micro)sclerotia, ascospores, basidiospores, chlamydospores or hyphal fragments.

Unlike many spores based on bacteria, such as bacillus spores, many fungal spores are less robust and it has proven to be difficult to provide fungal spores in a form which meets the needs of commercial products, in particular acceptable storage stability at certain temperatures.

The provision of suitable formulations for biological control agents nevertheless still poses a challenge due to the many factors contributing to the efficacy of the final formulation such as nature of the biological control agent, temperature stability and shelf life as well as effects of the formulation in the application.

Suitable formulations are homogeneous and stable mixtures of active and inert ingredients which make the final product simpler, safer, and more efficacious to apply to a target.

Commonly used formulations for biological control agents include WP, a solid formulation micronized to powder form and typically applied as suspended particles after dispersion in water, and WG, a formulation consisting of granules to be applied after disintegration and dispersion in water. The granules of a WG product has distinct particles within the range 0.2 to 4 mm. Water dispersible granules can be formed by agglomeration, spray drying, or extrusion techniques. WP formulations are produced rather easily but they are dusty. Further, they are not easy to dose in the field. WG formulations are easier to handle for the user and in general have lower dust content than WP formulations.

An example for a liquid formulation is SC, a water-based suspension of solid active ingredient in a fluid usually intended for dilution with water before use. Another liquid formulation type is EC, a solution of active ingredient combined with surfactants like e. g. emulsifying agents in a water insoluble organic solvent which will form an emulsion when added to water.

An enormous number of formulants have been utilized in experimental and commercial formulations of biological control agents (for a more detailed description and list see Schisler et al., Phytopathology, Vol 94, No. 11, 2004). Generally, formulants can be grouped as either carriers (fillers, extenders) or formulants that improve the chemical, physical, physiological or nutritional properties of the formulated biomass.

Stability, particularly storage stability of BCAs based on fungal actives over a longer period of time at temperatures at or above room temperature is a particular challenge due to the delicate nature of the fungal conidia. Like many living organisms, fungal conidia in their dormant state are sensible to environmental influences like e.g. water, air (oxygen), temperature, irradiation etc. Some factors may trigger germination while others may have detrimental effects to the spore viability. In order to exclude water, oils like white mineral (paraffinic) oils or plant oils are typically used to prepare liquid fungal spore formulations. Many of these oils provide some shelf life for fungal organisms, however preparations based on oils require emulsifiers that often have detrimental effects on spore viability over a long time and/or at elevated temperatures.

An example for a formulation of a biological control agent is described in Tones et al., 2003, J Appl Microbiol, 94(2), pp: 330-9). However, it is clear that a formulation preserving viability of the biological control agent, e. g. fungal spores, of more than 70% for 4 months at 4 degrees ° C. only is not suitable for everyday use in the field. Rather, it is desirable that formulations of biological control agents have a sufficient shelf life even under conditions where cold storage is not possible.

Kim et al., 2010 (J. S. Kim, Y. H. Je, J. Y. Roh, Journal of Industrial Microbiology & Biotechnology 2010, vol 37 (issue 4), pp, 419ff) disclose that conidia of the fungus Isaria fumosorosea show improved stability during a 2 and 8 hour heat treatment at 50° C. when dispersed in oils (Soybean, corn, cotton seed, paraffin oil, methyl oleate) in comparison to dispersion in water.

Mbarga et al., 2014 (Biological Control 2014, vol. 77, pp. 15ff) found that Trichoderma asperellum formulated in soybean oil with different emulsifiers shows improved shelf life in comparison to a dispersion of conidia in water.

Other liquids like e.g. ethoxylated trisiloxanes (e.g. Break-Thru 5240) are suitable alternatives and provide stable preparations e.g. with P. Lilacinum (BioAct®, see WO2016/050726), however manufacturing of such trisiloxanes and thus of the products themselves are expensive.

Oil-based suspensions containing fungal spores are known in the art. Typical examples for oils that are used for such purposes are e.g. vegetable oils, paraffin oils or aromatic hydrocarbons. WO 2015/069708 A1 describes liquid formulations of microbials based on paraffin oil together with up to 35% of emulsifiers that cause less residues on plastic surfaces. US 2007/0141032 A1 describes formulations of microbials based on paraffin oils containing a drying agent and up to 10% emulsifiers.

US 20140143909 A1 describes the general use of surfactants as “optional components” or co-formulants in liquid or solid compositions containing fungal spores.

Surfactants are furthermore used for water-based preparations. For example, US 2006/0247150 and US 2011/0033436 A1 describe water-based formulations that also comprise microbials and various nonionic, anionic, cationic and amphoteric surfactants.

With the disadvantages described above there is still the need for simple, easy to handle formulation recipes for biological control agents based on fungal actives. Among other properties, such formulations shall ideally provide a good physical stability in the formulation concentrate, exhibit a suitable shelf life over time, in particular at elevated temperatures (20° C. or greater), and provide good water miscibility or suspensibility.

As discussed above, there is only very little precedence that organic fluids other than oils or organosilicones can be used to provide stable agrochemical preparations of fungal spore based BCAs. Ethoxylated and/or propoxylated surfactants are known to have emulsifying properties, and hence these compounds are frequently used as emulsifiers employing typical quantities. Surprisingly it was found that a large number of different ethoxylated and/or propoxylated-ethoxylated fluids provided good to excellent spore viability after storage at elevated temperatures (8 weeks at 30° C. and beyond) when used as main carrier.

Accordingly, in a first aspect, the present invention relates to a liquid preparation comprising at least one ethoxylated and/or propoxylated organic liquid which is selected from the group consisting of
a) ethoxylated fatty acid triglycerides with 3-10 ethylene oxide units, wherein the fatty acid triglycerides are selected from the group consisting of castor oil and plant oils;
b) a block copolymer of the general formula

H—O—[CH2-CH2-O-]a1-[CH2-CH(CH3)-O]b-[CH2-CH2-O-]a2-H
where a1, a2 and b have independently from each other an average value of between 1 and 10; or
where a1 and a2 have independently from each other an average value of between 1 and 20 and b has an average value of between 15 and 35; and
c) a polymer of the general formula

X—O—[CH2-CH(CH3)-O]m-[CH2-CH2-O-]n-Y
where X and Y are independently selected from hydrogen, branched or linear alkyl with 1-24 carbon atoms, and branched or linear carbonyl with 2-24 carbon atoms, saturated or partially unsaturated, optionally carrying hydroxyl functionality;
where m is an average number between 0 and 10;
where n is an average number between 0 and 40, preferably between 0 and 30, more preferably between 0 and 20; most preferably between 0 and 15 or even between 0 and 10; where m+n is not zero
or a mixture of any one of a) to c);
and fungal spores.

Fungal spores as within the scope of the present invention comprise asexual spores called conidia as well as blastospores, but also other fungal propagules such as ascospores, basidiospores, chlamydospores. (Micro)Sclerotia, although not being spores in the strict sense, may also be added to the liquid preparation according to the invention.

Mixtures of any one of a) and b) can be present in ratios ranging from 1:100 to 100:1, preferably in ratios ranging from 1:50 to 50:1, more preferably in mixtures ranging from 1:25 to 25:1, such as 1:20, 1:15, 1:10, 1:5, 1:2, 1:1, 2:1, 5:1, 10:1, 15:1 or 20:1. Yet another preferred embodiment comprises mixtures of any one of a) and b) in ratios ranging from 1:20 to 1:1, or in ratios ranging from 1:1 to 20:1.

Mixtures of any one of a) and c) can be present in ratios ranging from 1:100 to 100:1, preferably in ratios ranging from 1:50 to 50:1, more preferably in mixtures ranging from 1:25 to 25:1, such as 1:20, 1:15, 1:10, 1:5, 1:2, 1:1, 2:1, 5:1, 10:1, 15:1 or 20:1. Yet another preferred embodiment comprises mixtures of any one of a) and c) in ratios ranging from 1:20 to 1:1, or in ratios ranging from 1:1 to 20:1.

Mixtures of any one of b) to c) can be present in ratios ranging from 1:100 to 100:1, preferably in ratios ranging from 1:50 to 50:1, more preferably in mixtures ranging from 1:25 to 25:1, such as 1:20, 1:15, 1:10, 1:5, 1:2, 1:1, 2:1, 5:1, 10:1, 15:1 or 20:1. Yet another preferred embodiment comprises mixtures of any one of b) and c) in ratios ranging from 1:20 to 1:1, or in ratios ranging from 1:1 to 20:1.

Mixtures of any one of a) and b) and c) can be present in ranges from either 1:1:100 to 100:100:1, or from 1:100:1 to 100:1:100, or from 100:1:1 to 1:100:100, respectively, preferably in ratios ranging from 1:1:50 to 50:50:1, or from 1:50:1 to 50:1:50, or from 50:1:1 to 1:50:50, more preferably in mixtures ranging from 1:1:25 to 25:25:1, or from 1:25:1 to 25:1:25, or from 25:1:1 to 1:25:25, such as 1:20:1, 1:15:1, 1:10:1, 1:5:1, 1:1:1, 20:1:1, 15:1:1, 10:1:1, 5:1:1, 1:1:20, 1:1:15, 1:1:10, 1:1:5, 5:20:1, 5:15:1, 5:10:1, 1:20:5, 1:15:5, 1:10:5, 20:1:5, 15:1:5, 10:1:5, 20:5:1, 15:5:1, 10:5:1, 1:5:20, 1:5:15, 1:5:10, 5:1:20, 5:1:15, or 5:1:10. Yet another preferred embodiment comprises mixtures of any one of a) and b) and c) in ratios ranging from 1:20:1 to 1:1:1, or in ratios ranging from 20:1:1 to 1:1:1, or in ratios ranging from 1:1:20 to 1:1:1.

It is preferred that the fungal spores are conidia.

In a preferred embodiment, said ethoxylated fatty acid triglycerides according to a) are derived from plant oils selected from the group consisting of sunflower oil, rapeseed oil, soybean oil, corn oil, coconut oil, and palm oil. For a review of the composition of said plant oils, please refer to http://www.dgfett.de/material/fszus.php.

In another preferred embodiment, said ethoxylated fatty acid triglycerides according to a) are derived from castor oil. Selected examples of ethoxalyted castor oils are e.g. Lucramul CO08 (Castor oil ethoxylate 8EO) and Etocas 10 (Castor oil ethoxylate 10EO) which are particularly preferred.

As to the ethoxylated and propoxylated organic liquid according to b), this is preferably selected from the group consisting of Block-Copolymers of the formula H—O—[CH2-CH2-O-]a1-[CH2-CH(CH3)-O]b-[CH2-CH2-O-]a2-H where a1 and a2 have independently from each other an average value of between 1 and 20 and b has an average value of between 15 and 35. More preferably, said ethoxylated and propoxylated organic liquid is selected from the group of Block-Copolymers where a1 and a2 have independently from each other an average value of between 1 and 16 and where b has an average value of between 20 and 30. Said ethoxylated and propoxylated organic liquid according to b) preferably has an average mol wt. of between about 1000 and about 3000 g/mol, more preferably between about 1500 g/mol and about 3000 g/mol, more preferably between about 2000 g/mol and about 3000 g/mol.

For example, for Block-Copolymers with an average value of a1 and a2 of between 3 and 16 and an average value of b of between 25 and 35, the average molecular weight may range between about 2000 and about 3000 g/mol. For Block-Copolymers with an average value of a1 and a2 of between 2 and 12 and an average value of b of between 15 and 25, the average molecular weight may range between about 1400 and about 2200 g/mol. For Block-Copolymers with an average value of a1 and a2 of between 1 and 12 and an average value of b of between 10 and 20, the average molecular weight may range between about 1000 and about 2000 g/mol.

Selected examples for ethoxylated and propoxylated organic liquid according to b) are represented by Synperonic PE/L62, Synperonic PE/L64 and Synperonic PE/L44 which are particularly preferred.

In another embodiment, the ethoxylated and propoxylated organic liquid according to b) is preferably selected from the group consisting of Block-Copolymers of the formula H—O—[CH2-CH2-O-]a1-[CH2-CH(CH3)-O]b-[CH2-CH2-O-]a2-H where a1, a2 and b have independently from each other an average value of between 1 and 8. More preferably, said Block-Copolymer has an average amount of 2 to 8 propylene oxide units and 2 to 12 ethylene oxide units, where a1 and a2 may independently from each other have a value not exceeding 12 in total. Even more preferably, said Block-Copolymer has an average amount of 2 to 6 propylene oxide units and 2 to 8 ethylene oxide units, where a1 and a2 may independently from each other have a value not exceeding 8 in total.

In this embodiment, said ethoxylated and propoxylated organic liquid according to b) preferably has an average mol wt. of between about 150 and about 1500 g/mol, more preferably between about 150 g/mol and about 1200 g/mol, more preferably between about 200 g/mol and about 1000 g/mol and even more preferably between about 200 and about 700 g/mol.

For example, for an average value of a1, a2 and b independently from each other of between 1 and 10, the average molecular weight may range between about 150 and about 1500 g/mol. For an average value of a1, a2 and b independently from each other of between 1 and 8, the average molecular weight may range between about 150 and about 1200 g/mol. For Block-Copolymers with an average amount of 2 to 8 propylene oxide units and 2 to 12 ethylene oxide units, where a1 and a2 may independently from each other have a value not exceeding 12 in total, the average molecular weight may range between about 200 g/mol and about 1000 g/mol. For Block-Copolymers with an average amount of 2 to 6 propylene oxide units and 2 to 8 ethylene oxide units, where a1 and a2 may independently from each other have a value not exceeding 8 in total, the average molecular weight may range between about 200 and about 700 g/mol.

In this embodiment, it is most preferred that in said ethoxylated and propoxylated organic liquid according to b), a1 and a2 have independently from each other a value of between 1 to 4 and b has a value of between 2 to 6.

In a preferred embodiment, in the polymer of c), X is branched or linear alkyl with 1-18 carbon atoms or branched or linear carbonyl with 2-18 carbon atoms, saturated or partially unsaturated, and Y is hydrogen, or branched or linear alkyl with 1-6 carbon atoms or branched or linear carbonyl with 2-6 carbon atoms, saturated or partially unsaturated. For the sake of clarity, the skilled person is aware that branched alkyl or carbonyl groups may only exist with at least 3 carbon atoms.

In an alternative preferred embodiment, in the polymer of c), X is hydrogen, or branched or linear alkyl with 1-6 carbon atoms (for the sake of clarity throughout the present application branched moieties have to have at least 3 carbon atoms), or branched or linear carbonyl with 2-6 carbon atoms, saturated or partially unsaturated, optionally carrying hydroxyl functionality and Y is branched or linear alkyl with 1-18 carbon atoms or branched or linear carbonyl with 2-18 carbon atoms, saturated or partially unsaturated, optionally carrying hydroxyl functionality. In a preferred embodiment, in the polymer of c) m+n is between 1 and 30, more preferably between 1 and 20, most preferably between 1 and 15. In an alternative preferred embodiment, m is in a range between 1 and 9 and n is in a range of between 0 and 6., or m is in a range of between 0 and 5 and n is in a range of between 3 and 10. In yet another preferred embodiment, m is in a range of between 1 to 5 where n equals zero, or n is in a range of between 4 and 10 where m equals zero.

In the foregoing, carbonyl refers to alkylcarbonyl, alkenylcarbonyl, alkinylcarbonyl as defined below.

As shown in the examples of the present application, it was found that fluids with rather low molecular weight still had the stabilizing effect according to the invention whereas other structurally similar fluids with a rather low molecular weight do not show this effect. Whereas Applicant does not wish to be bound by any scientific theory, it is believed that certain structural motifs of fluids such as the combination of rather small alkyl chains together with a certain number of ethylene oxide units are not suitable to stabilize fungal spores but result in the opposite. Surprisingly, this behavior is not observed when the very same small alkyl chains are combined with a certain number of propylene oxide units. Accordingly, in another preferred embodiment, in the polymer of c), if m equals zero the molecular weight (MW) of said at least one ethoxylated organic liquid is greater than or equal to 190 mass units, more preferably greater than or equal to 205 mass units, even more preferably greater than or equal to 220 mass units, such as at least 235 mass units.

Whereas the skilled person is able to define which liquids fall within the scope of the present invention, it is preferred that said ethoxylated and/or propoxylated organic liquid according to c) is selected from the group consisting of polyethylene glycols, such as Pluriol E300 (polyethyleneglycol-300); ethoxylated alcohols, such as Atplus 245 (alcohol ethoxylate), Berol 050 (linear C12-C16 ethoxylated alcohol, 3EO), Berol 260 (C9-C11 ethoxylated alcohol, 4EO), Ecosurf EH3 (Triethylenglycol-monooctylether), Lucramul L03 (C12-C18 ethoxyated alcohols, 3EO), Lucramul L05 (C12-C18 ethoxyated alcohols, 5EO), Lutensol AO3 (C13-15-branched and linear ethoxylated alcohols, 3EO), Lutensol AO7 (C13-15-branched and linear ethoxylated alcohols, 7EO), Triethylenglycolmonobutylether; mono-/polyethylene oxide diethers, such as Tetraglyme (Tetraethylenglycol diether); mono-/polyethylene oxide ether-ester, such as Arlatone TV (Sorbitol-Heptaoleate, 40EO), n-Butyldiglycolacetat, Tween 20 (ethoxylated sorbitol monolaurate, 20EO), Tween-80 (ethoxylated sorbitol monooleate, 20EO), Tween-85 (ethoxylated sorbitol monooleate, 20EO); ethoxylated carboxylic acids, such as Alkamuls A (Polyethylene glycol Monooleate), Radiasurf 7402 (polyethyleneglycol-200 monooleate), Radiasurf 7403 (polyethyleneglycol-400 monooleate), Radiasurf 7423 (polyethyleneglycol-400 monolaurate); mono-/polyethylene oxide di-esters, such as Radiasurf 7442 (polyethyleneglycol-400 dioleate); polypropylene glycols, such as Dipropylene glycol; propoxylated alcohols, such as Dowanol DPM (Dipropylene Glycol monomethyl ether); mono-/polypropylene oxide diethers, such as Dipropylene glycol dimethyl ether; mono-/polypropylene oxide ether-ester, such as Dipropylene glycol methyl ether acetate; propoxylated carboxylic acids; mono-/polypropylene oxide di-esters, such as Propylenglycol diacetate; alcohol propoxylate-ethoxylates, such as Atlas G-5002L (Alcohol propoxylate-ethoxylate), Lucramul HOT 5902 (Alcohol propoxylate-ethoxylate); carboxylic acid propoxylate-ethoxylate; carboxylic acid propoxylate-ethoxylate ether, such as Leofat 000503M (Fatty acid, Propoxylated-ethoxylated, end-capped Methyl Fatty acid, Propoxylated-ethoxylated, end-capped Methyl).

In another preferred embodiment and adding to the above, ethoxylated alcohols butylcarbitol, butylcellosolve, hexylcellosolve, methoxytriglycol and propylcellosolve are not within the scope of the liquids according to c). In the course of the present invention, it has been surprisingly found that certain liquids as defined herein are suitable to increase storage stability of fungal spores. In other words, fungal spores present in the liquid preparation according to the invention display an improved germination rate after a given time as compared to fungal spores present in a different formulation or in pure form.

If not indicated otherwise, the term “%” as used throughout the present application relates to weight (wt.) %.

In connection with the present invention, an “improved germination rate” refers to a germination rate of dormant fungal structures or organs, preferably fungal spores, which is at least 10% higher than that of dormant fungal structures or organs, such as spores not treated according to the procedure of the present invention but treated equally otherwise (“control spores”), preferably at least 20%, more preferably at least 30% or at least 40% and most preferably at least 50% higher until at least 2 weeks after production of said spores, that is after finishing the cooling period. In other words, “improved germination rate” means a germination rate of at least 110% of that of control spores, preferably at least 120%, more preferably at least 130% or at least 140% and most preferably at least 150% or higher until at least 2 weeks after production of said spores. Preferably, said improved germination rate is still visible or even increased until at least 3 months after production, more preferably at least 4 months and most preferably at least 6 months after production, such as at least 8 months, at least 10 months or even 12 months or more. Accordingly, it is preferred that the germination rate of spores treated according to the invention is at least 200% of that of control spores 3 months after production of said spores. In another preferred embodiment, the germination rate is at least 300% or at least 400%, most preferably at least 500% of that of control spores 6 months after production of said spores. The germination rate in this connection denotes the ability of spores to still germinate after a given time. % germination rate accordingly means the percentage of spores which is able to germinate after a given time. Methods of measuring the germination rate are well-known in the art. For example, spores are spread onto the surface of an agar medium, and the proportion of spores developing germ tubes is determined microscopically after incubation at appropriate growth temperatures (Oliveira et al., 2015. A protocol for determination of conidial viability of the fungal entomopathogens Beauveria bassiana and Metarhizium anisopliae from commercial products. Journal of Microbiological Methods 119; pp: 44-52, and references therein).

In a particular embodiment, the invention provides for a liquid preparation comprising

0.1-40% of fungal spores, preferred 2.5-30%, most preferred 5-25%, such as 10-20%,
up to 99.9% of an ethoxylated and/or propoxylated organic liquid as defined above, preferred 70 up to 97.5%, most preferred 75 up to 95%; such as 80-90%,
0-10% of surfactants (e.g. dispersants emulsifiers); preferred 0-8%, most preferred 0.1-5%;
0-10% of rheology modifiers, e.g. fumed silicas, attapulgites, preferably 0-7%, more preferably 0.5-5%;
0-5% of each antifoams, antioxidants, dyes preferred 0-3%, most preferred 0.1-0.5% of each.

As long as not defined otherwise, the term “alkyl” refers to saturated straight-chain or branched hydro-carbon radicals such as (C1-C18)-, (C1-C6)-, or (C1-C4)-alkyl. Examples: methyl, ethyl, propyl, 1-methyl-ethyl, butyl etc.

Examples (but not limited to): (C1-C6)-alkyl such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl.

As long as not defined otherwise, the term “alkenyl” refers to unsaturated straight-chain or branched hydrocarbon radicals comprising at least one double bond such as (C2-C18)-, (C2-C6)- or (C2-C4)-alkenyl. Examples: ethenyl, 1-propenyl, 3-butenyl etc.

Examples (but not limited to): (C2-C6)-alkenyl such as ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl.

As long as not defined otherwise, the term “alkoxy” (alkyl-O—) refers to alkyl radicals bound to the scaffold via an oxygen atom (—O—) such as (C1-C18)-, (C1-C6)- or (C1-C4)-alkoxy. Examples: methoxy, ethoxy, propoxy, 1-methylethoxy, etc.

Examples (but not limited to): (C1-C6)-alkoxy such as methoxy, ethoxy, propoxy, 1-methylethoxy, butoxy, 1-methylpropoxy, 2-methylpropoxy, 1,1-dimethylethoxy, pentoxy, 1-methylbutoxy, 2-methyl-butoxy, 3-methylbutoxy, 1,1-dimethylpropoxy, 1,2-dimethylpropoxy, 2,2-dimethylpropoxy, 1-ethyl-propoxy, hexoxy, 1-methylpentoxy, 2-methylpentoxy, 3-methylpentoxy, 4-methylpentoxy, 1,1-di-methylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy, and 1-ethyl-2-methylpropoxy.

Likewise, as long as not defined otherwise, the terms “alkenoxy” and “alkynoxy” refer to alkenyl or, respectively, alkynyl radicals bound to the scaffold via —O— such as (C2-C18)-, (C2-C6)- or (C2-C4)-alkenoxy or, respectively, (C3-C10)-, (C3-C6)- or (C3-C4)-alkynoxy.

As long as not defined otherwise, the term “alkylcarbonyl” (alkyl-C(═O)—) refers to alkyl radicals bound to the scaffold via —C(═O)— such as (C1-C18)-, (C1-C6)- or (C1-C4)-alkylcarbonyl. The number of C-atoms thereby refers to the alkyl radical within the alkylcarbonyl group.

Likewise, as long as not defined otherwise, the terms “alkenylcarbonyl” and “alkynylcarbonyl” refer to alkenyl or, respectively, alkynyl radicals bound to the scaffold via —C(═O)— such as (C2-C18)-, (C2-C6)- or (C2-C4)-alkenylcarbonyl or, respectively, (C2-C10)-, (C2-C6)- or (C2-C4)-alkynylcarbonyl. The number of C-atoms thereby refers to the alkenyl or, respectively, alkynyl radical within the alkenylcarbonyl or, respectively, alkynylcarbonyl group.

As long as not defined otherwise, the term “alkoxycarbonyl” (alkyl-O—C(═O)—) refers to alkyl radicals bound to the scaffold via —O—C(═O)— such as (C1-C18)-, (C1-C6)- or (C1-C4)-alkoxy-carbonyl. The number of C-atoms thereby refers to the alkyl radical within the alkoxycarbonyl group.

Likewise, as long as not defined otherwise, the terms “alkenoxycarbonyl” and “alkynoxycarbonyl” refer to alkenyl or, respectively, alkynyl radicals bound to the scaffold via —O—C(═O)— such as (C2-C10)-, (C2-C6)- or (C2-C4)-alkenoxycarbonyl or, respectively, (C3-C10)-, (C3-C6)- or (C3-C4)-alkynoxycarbonyl. The number of C-atoms thereby refers to the alkenyl or, respectively, alkynyl radical within the alkenoxycarbonyl or, respectively, alkynoxycarbonyl group.

As long as not defined otherwise, the term “alkylcarbonyloxy” (alkyl-C(═O)—O—) refers to alkyl radicals bound to the scaffold via —C(═O)—O—such as (C1-C10)-, (C1-C6)- or (C1-C4)-alkylcarbonyloxy. The number of C-atoms thereby refers to the alkyl radical within the alkylcarbonyloxy group.

Likewise, as long as not defined otherwise, the terms “alkenylcarbonyloxy” and “alkynylcarbonyloxy” refer to alkenyl or, respectively, alkynyl radicals bound to the scaffold via —C(═O)—O—such as (C2-C10)-, (C2-C6)- or (C2-C4)-alkenylcarbonyloxy or, respectively, (C2-C10)-, (C2-C6)- or (C2-C4)-alkynylcarbonyloxy. The number of C-atoms thereby refers to the alkenyl or, respectively, alkynyl radical within the alkenylcarbonyloxy or, respectively, alkynylcarbonyloxy group.

In a preferred embodiment, the composition according to the present invention is essentially free of water. BCAs are living organisms in a dormant form. Accordingly, formulations comprising a low concentration of water or even being essentially free of water are a preferred formulation type for BCAs. On the other hand, certain BCAs may also be formulated in higher water contents. If water is present, such water mainly comes from residual free water in the dried spore powder or traces of water in the other formulants. Accordingly, water concentrations of between 0 and 12 wt.-%, preferably 0 and 8 wt.-% are possible due to these facts, which range would then fall within the definition of “essentially free of water”. In other words, the term “essentially free of water” refers to a concentration of water in the composition of 12% or less, preferably 8 wt.-% or less. More preferably, the water concentration ranges between 0 and 6%, more preferably between 0 and 4% such as between 2 and 4 wt.-%. Accordingly, exemplary water concentrations include 2 wt.-%, 3 wt.-%, 4 wt.-%, 5 wt.-% and 6 wt.-%.

Whereas it is believed that in the liquid preparation according to the invention said ethoxylated and/or propoxylated organic liquid may be present in lower amount, such as at least 40 wt.-%, it is preferred that it is present in an amount of at least 50 wt.-%. Generally, said ethoxylated and/or propoxylated organic liquid may be present in a concentration of up to 99.9 wt.-%, preferably in a range of between 70 wt.-% and 97.5 wt.-%, more preferably between 75 wt.-% and 95 wt.-%, most preferably between 80 wt.-% and 90 wt.-%.

The liquid preparation according to the invention is preferably water-miscible. The term “water-miscible” indicates that said liquids are resulting in a homogeneous mixture if combined in a ratio of 1:200 of fluid and water, preferably in a ratio of 1:100, more preferably in a ratio of 1:50.

In one preferred embodiment, the composition is essentially free of oil. In connection with the present invention, an oil shall be defined as any liquid which is essentially not water-miscible or self-emulsifyable in water, e.g. paraffinic oils, fatty acid triglycerides, fatty acid monoesters, certain silicone oils, aromatic solvents or other water-immiscible organic solvents. The term “essentially free of oil” refers to a content of oil of 5 wt.-% or less, preferably 4 wt.-% or less, even more preferably 3 wt.-% or less and most preferably 2 wt.-% or less such as 1 wt.-%, 0.1 wt.-%, 0.05 wt.-% or even 0.01 wt.-%. It cannot be excluded that the composition of the present invention contains traces of oil due to the production process of its ingredients. The formulation of the present invention does not contain oil except for such traces.

Any fungal species may be applied for the present invention. It is, however, preferred that said fungal spores are from a fungal species which have a beneficial effect on plants, such as a fungal species which is effective as biological control agent in plant protection or acts as a plant health promoting agent, such as supporting or promoting plant growth and/or plant health. More preferably, said fungus is a filamentous fungus.

Filamentous fungi, as the skilled person is well aware, are distinguished from yeasts because of their tendency to grow in a multicellular, filamentous form under most conditions, in contrast to the primarily unicellular growth of oval or elliptical yeast cells.

Said at least one filamentous fungus may be any fungus exerting a positive effect on plants such as a plant protective or plant growth promoting effect. Accordingly, said fungus may be an entomopathogenic fungus, a nematophagous fungus, a plant growth promoting fungus, a fungus active against plant pathogens such as bacteria or fungal plant pathogens, or a fungus with herbicidal action.

NRRL is the abbreviation for the Agricultural Research Service Culture Collection, an international depositary authority for the purposes of deposing microorganism strains under the Budapest treaty on the international recognition of the deposit of microorganisms for the purposes of patent procedure, having the address National Center for Agricultural Utilization Research, Agricultural Research service, U.S. Department of Agriculture, 1815 North university Street, Peroira, Ill. 61604 USA.

ATCC is the abbreviation for the American Type Culture Collection, an international depositary authority for the purposes of deposing microorganism strains under the Budapest treaty on the international recognition of the deposit of microorganisms for the purposes of patent procedure, having the address ATCC Patent Depository, 10801 University Blvd., Manassas, Va. 10110 USA.

Only few fungi with selective herbicidal activity are known, such as F2.1 Phoma macrostroma, in particular strain 94-44B; F2.2 Sclerotinia minor, in particular strain IMI 344141 (e.g. Sarritor by Agrium Advanced Technologies); F2.3 Colletotrichum gloeosporioides, in particular strain ATCC 20358 (e.g. Collego (also known as LockDown) by Agricultural Research Initiatives); F2.4 Stagonospora atriplicis; or F2.5 Fusarium oxysporum, different strains of which are active against different plant species, e.g. the weed Striga hermonthica (Fusarium oxysproum formae specialis strigae).

Exemplary species of plant growth/plant health supporting, promoting or stimulating fungi are E2.1 Talaromyces flavus, in particular strain V117b; E2.2 Trichoderma atroviride, in particular strain CNCM 1-1237 (e.g. Esquive® WP from Agrauxine, FR), strain SC1 described in International Application No. PCT/IT2008/000196), strain no. V08/002387, strain no. NMI No. V08/002388, strain no. NMI No. V08/002389, strain no. NMI No. V08/002390, strain LC52 (e.g. Sentinel from Agrimm Technologies Limited), strain kd (e.g. T-Gro from Andermatt Biocontrol), and/or strain LUI32 (e.g. Tenet from Agrimm Technologies Limited); E2.3 Trichoderma harzianum, in particular strain ITEM 908 or T-22 (e.g. Trianum-P from Koppert); E2.4 Myrothecium verrucaria, in particular strain AARC-0255 (e.g. DiTera™ from Valent Biosciences); E2.5 Penicillium bilaii, in particular strain ATCC 22348 (e.g. JumpStart® from Acceleron BioAg), and/or strain ATCC20851; E2.6 Pythium oligandrum, in particular strains DV74 or M1 (ATCC 38472; e.g. Polyversum from Bioprepraty, CZ); E2.7 Rhizopogon amylopogon (e.g. comprised in Myco-Sol from Helena Chemical Company); E2.8 Rhizopogon fulvigleba (e.g. comprised in Myco-Sol from Helena Chemical Company); E2.9 Trichoderma harzianum, in particular strain TSTh20, strain KD, product Eco-T from Plant Health Products, ZA or strain 1295-22; E2.10 Trichoderma koningii; E2.11 Glomus aggregatum; E2.12 Glomus clarum; E2.13 Glomus deserticola; E2.14 Glomus etunicatum; E2.15 Glomus intraradices; E2.16 Glomus monosporum; E2.17 Glomus mosseae; E2.18 Laccaria bicolor; E2.19 Rhizopogon luteolus; E2.20 Rhizopogon tinctorus; E2.21 Rhizopogon villosulus; E2.22 Scleroderma cepa; E2.23 Suillus granulatus; E2.24 Suillus punctatapies; E2.25 Trichoderma virens, in particular strain GL-21; and E2.26 Verticillium albo-atrum (formerly V. dahliae), in particular strain WCS850 (CBS 276.92; e.g. Dutch Trig from Tree Care Innovations); E2.27 Trichoderma viride, e.g. strain B35 (Pietr et al., 1993, Zesz. Nauk. A R w Szczecinie 161: 125-137) and E2.28 Purpureocillium lilacinum (previously known as Paecilomyces lilacinus) strain 251 (AGAL 89/030550; e.g. BioAct from Bayer CropScience Biologics GmbH).

In a more preferred embodiment, fungal strains having a beneficial effect on plant health and/or growth are selected from Talaromyces flavus, strain VII7b; Trichoderma harzianum strain KD or strain in product Eco-T from Plant Health Products, SZ; Myrothecium verrucaria, in particular strain AARC-0255; Penicillium bilaii, strain ATCC 22348; and Pythium oligandrum, strain DV74 or M1 (ATCC 38472); Trichoderma viride strain B35; Trichoderma atroviride strain CNCM 1-1237, and Purpureocillium lilacinum (previously known as Paecilomyces lilacinus) strain 251 (AGAL 89/030550).

In an even more preferred embodiment, fungal strains having a beneficial effect on plant health and/or growth are selected from Penicillium bilaii strain ATCC 22348, Trichoderma viride, e.g. strain B35, Trichoderma atroviride strain CNCM 1-1237 and Purpureocillium lilacinum (previously known as Paecilomyces lilacinus) strain 251 (AGAL 89/030550).

Bactericidally active fungi are e.g.: A2.2 Aureobasidium pullulans, in particular blastospores of strain DSM14940; A2.3 Aureobasidium pullulans, in particular blastospores of strain DSM 14941 or mixtures of blastospores of strains DSM14940 and DSM14941; A2.9 Scleroderma citrinum.

Fungi active against fungal pathogens are e.g. B2.1 Coniothyrium minitans, in particular strain CON/M/91-8 (Accession No. DSM-9660; e.g. Contans® from Bayer CropScience Biologics GmbH); B2.2 Metschnikowia fructicola, in particular strain NRRL Y-30752; B2.3 Microsphaeropsis ochrace, in particular strain P130A (ATCC deposit 74412); B2.4 Muscodor albus, in particular strain QST 20799 (Accession No. NRRL 30547); B2.5 Trichoderma harzianum rifai, in particular strain KRL-AG2 (also known as strain T-22, /ATCC 208479, e.g. PLANTSHIELD T-22G, Rootshield®, and TurfShield from BioWorks, US) and strain T39 (e.g. Trichodex® from Makhteshim, US); B2.6 Arthrobotrys dactyloides; B2.7 Arthrobotrys oligospora; B2.8 Arthrobotrys superba; B2.9 Aspergillus flavus, in particular strain NRRL 21882 (e.g. Afla-Guard® from Syngenta) or strain AF36 (e.g. AF36 from Arizona Cotton Research and Protection Council, US); B2.10 Gliocladium roseum (also known as Clonostachys rosea f. rosea), in particular strain 321U from Adjuvants Plus, strain ACM941 as disclosed in Xue (Efficacy of Clonostachys rosea strain ACM941 and fungicide seed treatments for controlling the root tot complex of field pea, Can Jour Plant Sci 83(3): 519-524), strain IK726 (Jensen D F, et al. Development of a biocontrol agent for plant disease control with special emphasis on the near commercial fungal antagonist Clonostachys rosea strain ‘IK726’; Australas Plant Pathol. 2007; 36:95-101), strain 88-710 (WO2007/107000), strain CR7 (WO2015/035504) or strains CRrO, CRM and CRr2 disclosed in WO2017109802; B2.11 Phlebiopsis (or Phlebia or Peniophora) gigantea, in particular strain VRA 1835 (ATCC 90304), strain VRA 1984 (DSM16201), strain VRA 1985 (DSM16202), strain VRA 1986 (DSM16203), strain FOC PG B20/5 (IMI390096), strain FOC PG SP log 6 (IMI390097), strain FOC PG SP log 5 (IMI390098), strain FOC PG BU3 (IMI390099), strain FOC PG BU4 (IMI390100), strain FOC PG 410.3 (IMI390101), strain FOC PG 97/1062/116/1.1 (IMI390102), strain FOC PG B22/SP1287/3.1 (IMI390103), strain FOC PG SH1 (IMI390104) and/or strain FOC PG B22/SP1190/3.2 (IMI390105) (Phlebiopsis products are e.g. Rotstop® from Verdera and FIN, PG-Agromaster®, PG-Fungler®, PG-IBL®, PG-Poszwald® and Rotex® from e-nema, DE); B2.12 Pythium oligandrum, in particular strain DV74 or M1 (ATCC 38472; e.g. Polyversum from Bioprepraty, CZ); B2.13 Scleroderma citrinum; B2.14 Talaromyces flavus, in particular strain V117b; B2.15 Trichoderma asperellum, in particular strain ICC 012 from Isagro or strain SKT-1 (e.g. ECO-HOPE® from Kumiai Chemical Industry), strain T34 (e.g. ASPERELLO® from Biobest Group NV and T34 BIOCONTROL® by Biocontrol Technologies S.L., ES); B2.16 Trichoderma atroviride, in particular strain CNCM 1-1237 (e.g. Esquive® WP from Agrauxine, FR), strain SC1 described in International Application No. PCT/IT2008/000196), strain 77B (T77 from Andermatt Biocontrol), strain no. V08/002387, strain NMI no. V08/002388, strain NMI no. V08/002389, strain NMI no. V08/002390, strain LC52 (e.g. Sentinel from Agrimm Technologies Limited), strain LUI32 (e.g. Tenet by Agrimm Technologies Limited), strain ATCC 20476 (IMI 206040), strain T11 (IMI352941/CECT20498), strain SKT-1 (FERM P-16510), strain SKT-2 (FERM P-16511), strain SKT-3 (FERM P-17021); B2.17 Trichoderma harmatum; B2.18 Trichoderma harzianum, in particular, strain KD, strain T-22 (e.g. Trianum-P from Koppert), strain TH35 (e.g. Root-Pro by Mycontrol), strain DB 103 (e.g. T-Gro 7456 by Dagutat Biolab); B2.19 Trichoderma virens (also known as Gliocladium virens), in particular strain GL-21 (e.g. SoilGard by Certis, US); B2.20 Trichoderma viride, in particular strain TV1 (e.g. Trianum-P by Koppert), strain B35 (Pietr et al., 1993, Zesz. Nauk. A R w Szczecinie 161: 125-137); B2.21 Ampelomyces quisqualis, in particular strain AQ 10 (e.g. AQ 100 by CBC Europe, Italy); B2.22 Arkansas fungus 18, ARF; B2.23 Aureobasidium pullulans, in particular blastospores of strain DSM14940, blastospores of strain DSM 14941 or mixtures of blastospores of strains DSM14940 and DSM 14941 (e.g. Botector® by bio-ferm, CH); B2.24 Chaetomium cupreum (e.g. BIOKUPRUM™ by AgriLife); B2.25 Chaetomium globosum (e.g. Rivadiom by Rivale); B2.26 Cladosporium cladosporioides, in particular strain H39 (by Stichting Dienst Landbouwkundig Onderzoek); B2.27 Dactylaria candida; B2.28 Dilophosphora alopecuri (e.g. Twist Fungus); B2.29 Fusarium oxysporum, in particular strain Fo47 (e.g. Fusaclean by Natural Plant Protection); B2.30 Gliocladium catenulatum (Synonym: Clonostachys rosea f catenulate), in particular strain J1446 (e.g. Prestop by Lallemand); B2.31 Lecanicillium lecanii (formerly known as Verticillium lecanii), in particular conidia of strain KV01 (e.g. Vertalec® by Koppert/Arysta); B2.32 Penicillium vermiculatum; B2.33 Trichoderma gamsii (formerly T. viride), in particular strain ICC080 CC 392151 CABI, e.g. BioDerma by AGROBIOSOL DE MEXICO, S.A. DE C.V.); B2.34 Trichoderma polysporum, in particular strain IMI 206039 (e.g. Binab TF WP by BINAB Bio-Innovation AB, Sweden); B2.35 Trichoderma stromaticum (e.g. Tricovab by Ceplac, Brazil); B2.36 Tsukamurella paurometabola, in particular strain C-924 (e.g. HeberNem®); B2.37 Ulocladium oudemansii, in particular strain HRU3 (e.g. Botry-Zen® by Botry-Zen Ltd, NZ); B2.38 Verticillium albo-atrum (formerly V. dahliae), in particular strain WCS850 (CBS 276.92; e.g. Dutch Trig by Tree Care Innovations); B2.39 Muscodor roseus, in particular strain A3-5 (Accession No. NRRL 30548); B2.40 Verticillium chlamydosporium; B2.41 mixtures of Trichoderma asperellum strain ICC 012 and Trichoderma gamsii strain ICC 080 (product known as e.g. BIO-TAM™ from Bayer CropScience LP, US), B2.42 Simplicillium lanosoniveum and B2.43 Trichoderma fertile (e.g. product TrichoPlus from BASF).

In a preferred embodiment, the biological control agent having fungicidal activity is selected from Coniothyrium minitans, in particular strain CON/M/91-8 (Accession No. DSM-9660)Aspergillus flavus, strain NRRL 21882 (available as Afla-Guard® from Syngenta) and strain AF36 (available as AF36 from Arizona Cotton Research and Protection Council, US); Gliocladium roseum strain 321U, strain ACM941, strain IK726, strain 88-710 (WO2007/107000), strain CR7 (WO2015/035504); Gliocladium catenulatum strain J1446; Phlebiopsis (or Phlebia or Peniophora) gigantea, in particular the strains VRA 1835 (ATCC 90304), VRA 1984 (DSM16201), VRA 1985 (DSM16202), VRA 1986 (DSM16203), FOC PG B20/5 (IMI390096), FOC PG SP log 6 (IMI390097), FOC PG SP log 5 (IMI390098), FOC PG BU3 (IMI390099), FOC PG BU4 (IMI390100), FOC PG 410.3 (IMI390101), FOC PG 97/1062/116/1.1 (IMI390102), FOC PG B22/SP1287/3.1 (IMI390103), FOC PG SH1 (IMI390104), FOC PG B22/SP1190/3.2 (IMI390105) (available as Rotstop® from Verdera and FIN, PG-Agromaster®, PG-Fungler®, PG-IBL®, PG-Poszwald®, and Rotex® from e-nema, DE); Pythium oligandrum, strain DV74 or M1 (ATCC 38472) (available as Polyversum from Bioprepraty, CZ); Talaromyces flavus, strain VII7b; Ampelomyces quisqualis, in particular strain AQ 10 (available as AQ 10® by CBC Europe, Italy); Gliocladium catenulatum (Synonym: Clonostachys rosea f catenulate) strain J1446, Cladosporium cladosporioides, e. g. strain H39 (by Stichting Dienst Landbouwkundig Onderzoek), Trichoderma virens (also known as Gliocladium virens), in particular strain GL-21 (e.g. SoilGard by Certis, US), Trichoderma atroviride strain CNCM 1-1237, strain 77B, strain LU132 or strain SC1, having Accession No. CBS 122089, Trichoderma harzianum strain T-22 (e.g. Trianum-P from Andermatt Biocontrol or Koppert), Trichoderma asperellum strain SKT-1, having Accession No. FERM P-16510 or strain T34, Trichoderma viride strain B35 and Trichoderma asperelloides JM41R (Accession No. NRRL B-50759).

In a more preferred embodiment, the fungal species having fungicidal activity is selected from Coniothyrium minitans, in particular strain CON/M/91-8 (Accession No. DSM-9660) (available as Contans® from Prophyta, Del.); Gliocladium roseum strain 321U, strain ACM941 or strain IK726; Gliocladium catenulatum strain J1446; Trichoderma virens (also known as Gliocladium virens) strain GL-21. Said fungal species may also preferably be Coniothyrium minitans strain CON/M/91-8 (Accession No. DSM-9660) or Gliocladium catenulatum strain J1446 or Trichoderma atroviride strain CNCM 1-1237 or Trichoderma viride strain B35.

Within fungicidally active fungi, the genus Trichoderma, in particular the species Trichoderma viride and Trichoderma atroviride, are especially preferred. Those include Trichoderma atroviride strain CNCM 1-1237; Trichoderma atroviride strain SC1, having Accession No. CBS 122089, WO 2009/116106 and U.S. Pat. No. 8,431,120 (from Bi-PA); Trichoderma atroviride strain 77B; Trichoderma atroviride strain LU132; Trichoderma viride strain B35. Particularly preferred are Trichoderma atroviride strain CNCM 1-1237 and Trichoderma viride strain B35.

Said fungal species may be an entomopathogenic fungus.

Fungi active against insects (entomopathogenic fungi) include C2.1 Muscodor albus, in particular strain QST 20799 (Accession No. NRRL 30547); C2.2 Muscodor roseus in particular strain A3-5 (Accession No. NRRL 30548); C2.3 Beauveria bassiana, in particular strain ATCC 74040 (e.g. Naturalis® from Intrachem Bio Italia); strain GHA (Accession No. ATCC74250; e.g. BotaniGuard Es and Mycotrol-O from Laverlam International Corporation); strain ATP02 (Accession No. DSM 24665); strain PPRI 5339 (e.g. BroadBand™ from BASF); strain PPRI 7315, strain R444 (e.g. Bb-Protec from Andermatt Biocontrol), strains IL197, IL12, IL236, IL10, IL131, IL116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecología (Costa Rica) No. 77); strain BaGPK; strain ICPE 279, strain CG 716 (e.g. BoveMax® from Novozymes); C2.4 Hirsutella citriformis; C2.5 Hirsutella thompsonii (e.g. Mycohit and ABTEC from Agro Bio-tech Research Centre, Ind.); C2.6 Lecanicillium lecanii (formerly known as Verticillium lecanii), in particular conidia of strain KV01 (e.g. Mycotal® and Vertalec® from Koppert/Arysta), strain DAOM198499 or strain DAOM216596; C2.9 Lecanicillium muscarium (formerly Verticillium lecanii), in particular strain VE 6/CABI(=IMI) 268317/CBS102071/ARSEF5128 (e.g. Mycotal from Koppert); C2.10 Metarhizium anisopliae var acridum, e.g. ARSEF324 from GreenGuard by Becker Underwood, US or isolate IMI 330189 (ARSEF7486; e.g. Green Muscle by Biological Control Products); C2.11 Metarhizium brunneum, e.g. strain Cb 15 (e.g. ATTRACAP® from BIOCARE); C2.12 Metarhizium anisopliae, e.g. strain ESALQ 1037 (e.g. from Metarril® SP Organic), strain E-9 (e.g. from Metarril® SP Organic), strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448; e.g. BIO 1020 by Bayer CropScience and also e.g. Met52 by Novozymes) or strain ICIPE 78; C2.15 Metarhizium robertsii 23013-3 (NRRL 67075); C2.13 Nomuraea rileyi; C2.14 Paecilomyces fumosoroseus (new: Isaria fumosorosea), in particular strains Apopka 97 (available as PreFeRal from Certis, USA), Fe9901 (available as NoFly from Natural industries, USA), ARSEF 3581, ARSEF 3302, ARSEF 2679 (ARS Collection of Entomopathogenic Fungal Cultures, Ithaca, USA), IfB01 (China Center for Type Culture Collection CCTCC M2012400), ESALQ1296, ESALQ1364, ESALQ1409 (ESALQ: University of Sao Paulo (Piracicaba, SP, Brazil)), CG1228 (EMBRAPA Genetic Resources and Biotechnology (Brasilia, DF, Brazil)), KCH J2 (Dymarska et al., 2017; PLoS one 12(10)): e0184885), HIB-19, HIB-23, HIB-29, HIB-30 (Gandarilla-Pacheco et al., 2018; Rev Argent Microbiol 50: 81-89), CHE-CNRCB 304, EH-511/3 (Flores-Villegas et al., 2016; Parasites & Vectors 2016 9:176 doi: 10.1186/s13071-016-1453-1), CHE-CNRCB 303, CHE-CNRCB 305, CHE-CNRCB 307 (Gallou et al., 2016; fungal biology 120 (2016) 414-423), EH-506/3, EH-503/3, EH-520/3, PFCAM, MBP, PSMB1 (National Center for Biololgical Control, Mexico; Castellanos-Moguel et al., 2013; Revista Mexicana De Micologia 38: 23-33, 2013), RCEF3304 (Meng et al., 2015; Genet Mol Biol. 2015 July-September; 38(3): 381-389), PF01-N10 (CCTCC No. M207088), CCM 8367 (Czech Collection of Microorganisms, Brno), SFP-198 (Kim et al., 2010; Wiley Online: DOI 10.1002/ps.2020), K3 (Yanagawa et al., 2015; J Chem Ecol. 2015; 41(12): 118-1126), CLO 55 (Ansari Ali et al., 2011; PLoS One. 2011; 6(1): e16108. DOI: 10.1371/journal.pone.0016108), IfTS01, IfTS02, IfTS07 (Dong et al. 2016/PLoS ONE 11(5): e0156087. doi:10.1371/journal.pone.0156087), P1 (Sun Agro Biotech Research Centre, India), If-02, If-2.3, If-03 (Farooq and Freed, 2016; DOI: 10.1016/j.bjm.2016.06.002), Ifr AsC (Meyer et al., 2008; J. Invertebr. Pathol. 99:96-102. 10.1016/j.jip.2008.03.007), PC-013 (DSMZ 26931), P43A, PCC (Carrillo-Perez et al., 2012; DOI 10.1007/s11274-012-1184-1), Pf04, Pf59, Pf109 (KimJun et al., 2013; Mycobiology 2013 December; 41(4): 221-224), FG340 (Han et al., 2014; DOI: 10.5941/MYCO.2014.42.4.385), Pfr1, Pfr8, Pfr9, Pfr10, Pfr11, Pfr12 (Angel-Sahagún et al., 2005; Journal of Insect Science), Ifr531 (Daniel and Wyss, 2009; DOI 10.1111/j.1439-0418.2009.01410.x), IF-1106 (Insect Ecology and Biocontrol Laboratory, Shanxi Agricultural University), I9602, I7284 (Hussain et al. 2016, DOI:10.3390/ijms17091518), 103011 (U.S. Pat. No. 4,618,578), CNRCB1 (Centro Nacional de Referencia de Control Biologico (CNRCB), Colima, Mexico), SCAU-IFCF01 (Nian et al., 2015; DOI: 10.1002/ps.3977), PF01-N4 (Engineering Research Center of Biological Control, SCAU, Guangzhou, P. R. China) Pfr-612 (Institute of Biotechnology (IB-FCB-UANL), Mexico), Pf-Tim, Pf-Tiz, Pf-Hal, Pf-Tic (Chan-Cupul et al. 2013, DOI: 10.5897/AJMR12.493); C2.15 Aschersonia aleyrodis; C2.16 Beauveria brongniartii (e.g. Beaupro from Andermatt Biocontrol AG); C2.17 Conidiobolus obscurus; C2.18 Entomophthora virulenta (e.g. Vektor from Ecomic); C2.19 Lagenidium giganteum; C2.20 Metarhizium flavoviride; C2.21 Mucor haemelis (e.g. BioAvard from Indore Biotech Inputs & Research); C2.22 Pandora delphacis; C2.23 Sporothrix insectorum (e.g. Sporothrix Es from Biocerto, BR); C2.24 Zoophtora radicans.

In a preferred embodiment, fungal strains having an insecticidal effect are selected from C2.3 Beauveria bassiana strain ATCC 74040; strain GHA (Accession No. ATCC74250); strain ATP02 (Accession No. DSM 24665); strain PPRI 5339; strain PPRI 7315, strain R444, strains IL197, IL12, IL236, IL10, IL131, IL116; strain BaGPK; strain ICPE 279, strain CG 716; C2.6 Lecanicillium lecanii (formerly known as Verticillium lecanii), in particular conidia of strain KV01, strain DAOM198499 or strain DAOM216596; C2.9 Lecanicillium muscarium (formerly Verticillium lecanii) strain VE 6/CABI(=IMI) 268317/CBS102071/ARSEF5128; C2.10 Metarhizium anisopliae var acridum strain ARSEF324 or isolate IMI 330189 (ARSEF7486); C2.11 Metarhizium brunneum strain Cb 15; C2.12 Metarhizium anisopliae, e.g. strain ESALQ 1037, strain E-9, strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448) or strain ICIPE 78; C2.14 Paecilomyces fumosoroseus (new: Isaria fumosorosea) strain Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pf109, FG340, Pfr1, Pfr8, Pfr9, Pfr10, Pfr11, Pfr12, Ifr531, IF-1106, I9602, I7284, I03011 (U.S. Pat. No. 4,618,578), CNRCB1, SCAU-IFCF01, PF01-N4, Pfr-612, Pf-Tim, Pf-Tiz, Pf-Hal and Pf-Tic.; and C2.16 Beauveria brongniartii (e.g. Beaupro from Andermatt Biocontrol AG).

In a more preferred embodiment, fungal strains having an insecticidal effect are selected from C2.3 Beauveria bassiana strain ATCC 74040; strain GHA (Accession No. ATCC74250); strain ATP02 (Accession No. DSM 24665); strain PPRI 5339; strain PPRI 7315 and/or strain R444; C2.6 Lecanicillium lecanii (formerly known as Verticillium lecanii), conidia of strain KV01, strain DAOM198499 or strain DAOM216596; C2.9 Lecanicillium muscarium (formerly Verticillium lecanii), in particular strain VE 6/CABI(=IMI) 268317/CBS102071/ARSEF5128; C2.10 Metarhizium anisopliae var acridum strain ARSEF324 or isolate IMI 330189 (ARSEF7486); C2.11 Metarhizium brunneum strain Cb 15; C2.12 Metarhizium anisopliae strain ESALQ 1037, strain E-9, strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448) or strain ICIPE 78; C2.14 Paecilomyces fumosoroseus (new: Isaria fumosorosea) strain Apopka 97 and Fe9901, and C2.16 Beauveria brongniartii (e.g. Beaupro from Andermatt Biocontrol AG).

It is even more preferred that said fungal microorganism is a strain of the species Isaria fumosorosea. Preferred strains of Isaria fumosorosea are selected from the group consisting of Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pf109, FG340, Pfr1, Pfr8, Pfr9, Pfr10, Pfr11, Pfr12, Ifr531, IF-1106, I9602, I7284, I03011 (U.S. Pat. No. 4,618,578), CNRCB1, SCAU-IFCF01, PF01-N4, Pfr-612, Pf-Tim, Pf-Tiz, Pf-Hal, Pf-Tic.

It is most preferred that said Isaria fumosorosea strain is selected from Apopka 97 and Fe9901. A particularly preferred strain is APOPKA97.

Also particularly preferred are entomopathogenic fungi of the genus Metarhizium spp. The genus Metahrizium comprises several species some of which have recently been re-classified (for an overview, see Bischoff et al., 2009; Mycologia 101 (4): 512-530). Members of the genus Metarhizium comprise M. pingshaense, M. anisopliae, M. robertsii, M. brunneum (these four are also referred to as Metarhizium anisopliae complex), M. acridum, M. majus, M. guizouense, M. Lepidiotae, M. Globosum and M. rileyi (previously known as Nomuraea rileyi). Of these, M. anisopliae, M. robertsii, M. brunneum, M. acridum and M. rileyi are even more preferred, whereas those of M. brunneum are most preferred.

Exemplary strains belonging to Metarhizium spp. which are also especially preferred are Metarhizium acridum ARSEF324 (product GreenGuard by BASF) or isolate IMI 330189 (ARSEF7486; e.g. Green Muscle by Biological Control Products); Metarhizium brunneum strain Cb 15 (e.g. ATTRACAP® from BIOCARE), or strain F52 (DSM3884/ATCC 90448; e.g. BIO 1020 by Bayer CropScience and also e.g. Met52 by Novozymes); Metarhizium anisopliae complex strains strain ESALQ 1037 or strain ESALQ E-9 (both from Metarril® WP Organic), strain M206077, strain C4-B (NRRL 30905), strain ESC1, strain 15013-1 (NRRL 67073), strain 3213-1 (NRRL 67074), strain C20091, strain C20092, or strain ICIPE 78. Most preferred are isolate F52 (a.k.a. Met52) which primarily infects beetle larvae and which was originally developed for control of Otiorhynchus sulcatus. and ARSEF324 which is commercially used in locust control. Commercial products based on the F52 isolate are subcultures of the individual isolate F52 and are represented in several culture collections including: Julius Kühn-Institute for Biological Control (previously the BBA), Darmstadt, Germany: [as M.a. 43]; HRI, UK: [275-86 (acronyms V275 or KVL 275)]; KVL Denmark [KVL 99-112 (Ma 275 or V 275)]; Bayer, Germany [DSM 3884]; ATCC, USA [ATCC 90448]; USDA, Ithaca, USA [ARSEF 1095]. Granular and emulsifiable concentrate formulations based on this isolate have been developed by several companies and registered in the EU and North America (US and Canada) for use against black vine weevil in nursery ornamentals and soft fruit, other Coleoptera, western flower thrips in greenhouse ornamentals and chinch bugs in turf.

Beauveria bassiana is mass-produced and used to manage a wide variety of insect pests including whiteflies, thrips, aphids and weevils. Preferred strains of Beauveria bassiana include strain ATCC 74040; strain GHA (Accession No. ATCC74250); strain ATP02 (Accession No. DSM 24665); strain PPRI 5339; strain PPRI 7315, strains IL197, IL12, IL236, IL10, IL131, IL116, strain Bv025; strain BaGPK; strain ICPE 279, strain CG 716; ESALQPL63, ESALQ447 and ESALQ1432, CG1229, IMI389521, NPP111B005, Bb-147. It is most preferred that Beauveria bassiana strains include strain ATCC 74040 and strain GHA (Accession No. ATCC74250). The liquid preparation according to any one of claims 1 to 17, wherein said fungal species is a nematicidally active fungus.

Nematicidally active fungal species include D2.1 Muscodor albus, in particular strain QST 20799 (Accession No. NRRL 30547); D2.2 Muscodor roseus, in particular strain A3-5 (Accession No. NRRL 30548); D2.3 Purpureocillium lilacinum (previously known as Paecilomyces lilacinus), in particular P. lilacinum strain 251 (AGAL 89/030550; e.g. BioAct from Bayer CropScience Biologics GmbH), strain 580 (BIOSTAT® WP (ATCC No. 38740) by Laverlam), strain in the product BIO-NEMATON® (T. Stanes and Company Ltd.), strain in the product MYSIS® (Varsha Bioscience and Technology India Pvt Ltd.), strain in the product BIOICONEMA® (Nico Orgo Maures, India), strain in the product NEMAT® (Ballagro Agro Tecnologia Ltda, Brazil), and a strain in the product SPECTRUM PAE L® (Promotora Tecnica Industrial, S.A. DE C.V., Mexico); D2.4 Trichoderma koningii; D2.5 Harposporium anguillullae; D2.6 Hirsutella minnesotensis; D2.7 Monacrosporium cionopagum; D2.8 Monacrosporium psychrophilum; D2.9 Myrothecium verrucaria, in particular strain AARC-0255 (e.g. DiTera™ by Valent Biosciences); D2.10 Paecilomyces variotii, strain Q-09 (e.g. Nemaquim® from Quimia, MX); D2.11 Stagonospora phaseoli (e.g. from Syngenta); D2.12 Trichoderma lignorum, in particular strain TL-0601 (e.g. Mycotric from Futureco Bioscience, ES); D2.13 Fusarium solani, strain Fs5; D2.14 Hirsutella rhossiliensis; D2.15 Monacrosporium drechsleri; D2.16 Monacrosporium gephyropagum; D2.17 Nematoctonus geogenius; D2.18 Nematoctonus leiosporus; D2.19 Neocosmospora vasinfecta; D2.20 Paraglomus sp, in particular Paraglomus brasilianum; D2.21 Pochonia chlamydosporia (also known as Vercillium chlamydosporium), in particular var. catenulata (IMI SD 187; e.g. KlamiC from The National Center of Animal and Plant Health (CENSA), CU); D2.22 Stagonospora heteroderae; D2.23 Meristacrum asterospermum and D2.24 Duddingtonia flagrans.

In a more preferred embodiment, fungal strains with nematicidal effect are selected from Purpureocillium lilacinum, in particular spores of P. lilacinum strain 251 (AGAL 89/030550); Harposporium anguillullae; Hirsutella minnesotensis; Monacrosporium cionopagum; Monacrosporium psychrophilum; Myrothecium verrucaria, strain AARC-0255; Paecilomyces variotii; Stagonospora phaseoli (commercially available from Syngenta); and Duddingtonia flagrans.

In an even more preferred embodiment, fungal strains with nematicidal effect are selected from Purpureocillium lilacinum, in particular spores of P. lilacinum strain 251 (AGAL 89/030550); and Duddingtonia flagrans. Most preferably, said fungal strain with nematicidal effect is from the species Purpureocillium lilacinum, in particular P. lilacinum strain 251.

The fungal microorganism producing spores and acting as biological control agent and/or plant growth promoter is cultivated or fermented according to methods known in the art or as described in this application on an appropriate substrate, e. g. by submerged fermentation or solid-state fermentation, e. g. using a device and method as disclosed in WO2005/012478 or WO1999/057239.

Although specific fungal propagules such as microsclerotia (see e.g. Jackson and Jaronski (2009). Production of microsclerotia of the fungal entomopathogen Metarhizium anisopliae and their potential for use as a biocontrol agent for soil-inhabiting insects; Mycological Research 113, pp. 842-850) may be produced by liquid fermentation techniques, it is preferred that the dormant structures or organs according to the present invention are produced by solid-state fermentation. Solid-state fermentation techniques are well known in the art (for an overview see Gowthaman et al., 2001. Appl Mycol Biotechnol (1), p. 305-352).

After fermentation, the fungal spores may be separated from the substrate. The substrate populated with the fungal spores is dried preferably before any separation step. The microorganism or fungal spores may be dried via e. g. freeze-drying, vacuum drying or spray drying after separation. Methods for preparing dried spores are well known in the art and include fluidized bed drying, spray drying, vacuum drying and lyophilization. Conidia may be dried in 2 steps: For conidia produced by solid-state fermentation first the conidia covered culture substrate is dried before harvesting the conidia from the dried culture substrate thereby obtaining a pure conidia powder. Then the conidia powder is dried further using vacuum drying or lyophilization before storing or formulating it.

The liquid preparation according to the invention may further comprise at least one substance selected from the group of surfactants, rheology modifiers, antifoaming agents, antioxidants and dyes.

Non-ionic and/or anionic surfactants are all substances of this type which can customarily be employed in agrochemical agents. Possible nonionic surfactants are selected from the groups of polyethylene oxide-polypropylene oxide block copolymers, polyethylene glycol ethers of branched or linear alcohols, reaction products of fatty acids or fatty acid alcohols with ethylene oxide and/or propylene oxide, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated and neutralized with bases. Possible anionic surfactants are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalenesulphonic acid-formaldehyde condensation products, salts of condensation products of naphthalenesulphonic acid, phenolsulphonic acid and formaldehyde, and salts of lignosulphonic acid.

Rheology modifiers, also known as thickener, anti-caking agent, viscosity modifier or structuring agent, may be added to the present formulation, e.g. in order to prevent (irreversible) sedimentation. Rheology modifiers are preferably derived from minerals. These rheological control agents provide long term stability when the formulation is at rest or in storage. Suitable compounds are rheological modifier selected from the group consisting of hydrophilic and hydrophobized fumed and precipitated silica particles, gelling clays including bentonite, hectorite, laponite, attapulgite, sepiolite, smectite, or hydrophobically/organophilic modified bentonite. Suitable ranges of rheology modifier in the liquid preparation according to the invention comprise 0-10%, preferably 0-7%, more preferably 0.5-5%.

As far as not otherwise defined, % in the present application refers to wt.-%.

In order to disperse silicas or clay thickeners in a given fluid high shear mixing is desirable to form a gel as it is known in the art.

Major global producers for fumed (pyrogenic) hydrophilic or hydrophobized silicas are Evonik (tradename Aerosil®), Cabot Corporation (tradename Cab-O-Sil®), Wacker Chemie (HDK product range), Dow Corning, and OCI (Konasil®). Another class of suitable rheology modifiers are precipitated silicas, and major global producers are Evonik (tradenames Sipernat® or Wessalon®), Rhodia (Tixosil) and PPG Industries (Hi-Sil).

Another class of suitable examples for rheology modifiers are clay thickeners. Clay thickeners are generally micronized layered silicates that can be effective thickeners for a wide range of applications. They are typically employed either in their non-hydrophobized or hydrophobized form. In order to make them dispersible in non-aqueous solvents, the clay surface is usually treated with quaternary ammonium salts. These modified clays are known as organo-modified clay thickeners. Optionally, small amounts of alcohols of low molecular weight or water may be employed as activators. Examples for such clay-based rheology modifiers include smectite, bentonite, hectorite, attapulgite, seipiolite or montmorillonite clays. Preferred rheological modifiers (b) are for example organically modified hectorite clays such as Bentone® 38 and SD3. organically modified bentonite clays, such as Bentone® 34, SD1 and SD2, organically modified sepiolite such as Pangel® B20, hydrophilic silica such as Aerosil® 200, hydrophobized silica such as Aerosil® R972, R974 and R812S, attapulgite such as Attagel® 50,

Another class of suitable examples for rheology modifiers are organic rheological modifiers based on modified hydrogentated castor oil (trihydroxystearin) or castor oil organic derivatives such as Thixcin® R and Thixatrol® ST.

Physical Properties of Selected Rheology Modifiers

| Tradename | Company | General description | Physical propeties | CAS- No. |
|---|---|---|---|---|
| Bentone ® 38 | Elementis | Organic derivative of a | Density: 1.7 | 12001-31-9 |
| | Specialties, US | hectorite clay | g/cm3 | |
| Bentone ® SD- | Elementis | Organic derivative of a | Density: 1.6 | |
| 3 | Specialties, US | hectorite clay | g/cm3 | |
| | | | Particle size | |
| | | | (dispersed): <1 | |
| | | | μm | |
| Bentone ® 34 | Elementis | Organic derivative of a | Density: 1.7 | 68953-58-2 |
| | Specialties, US | bentonite clay | g/cm3 | |
| Bentone ® SD- | Elementis | Organic derivative of a | Density: 1.47 | 89749-77-9 |
| 1 | Specialties, US | bentonite clay | g/cm3 | |
| Bentone ® SD- | Elementis | Organic derivative of a | Density: 1.62 | 89749-78-0 |
| 2 | Specialties, US | bentonite clay | g/cm3 | |
| Pangel ® B20 | Tolsa S.A., ES | Organically modified | | 63800-37-3 |
| | | sepiolite | | |
| Sipernat ® 22S | Evonik | Precipitated amorphous | *BET: 190 m2/g | 112926-00-8 |
| | Industries AG, | silicon dioxide | Average primary | |
| | DE | | particle size: 12 | |
| | | | nm | |
| Aerosil ® 200 | Evonik | Hydrophilic fumed | *BET: 200 m2/g | 112945-52-5 |
| | Industries AG, | silica | Average primary | 7631-86-9 |
| | DE | | particle size: 12 | |
| | | | nm | |
| Aerosil ® R | Evonik | Hydrophobized fumed | *BET: 90-130 | 68611-44-9 |
| 972/R972V | Industries AG, | silica | m2/g | |
| | DE | | | |
| Aerosil ® R | Evonik | Hydrophobized fumed | *BET: 150-190 | 68611-44-9 |
| 974 | Industries AG, | silica | m2/g | |
| | DE | | | |
| Aerosil ® R | Evonik | Hydrophobized fumed | *BET: 260 ± 30 | 68909-20-6 |
| 812S | Industries AG, | silica | m2/g | |
| | DE | | | |
| Attagel ® 50 | BASF AG, DE | Attapulgite clay: | Density: >1.0 | 14808-60-7 |
| | | (Mg, Al)5Si8O20•4H2O | g/cm3 | |
| | | | Average particle | |
| | | | size: 9 μm | |
| Thixcin ® R | Elementis | organic derivative of | Density: 1.02 | 38264-86-7 |
| | Specialties, US | castor oil | g/cm3 | |
| Thixatrol ® ST | Elementis | organic derivative of | Density: 1.02 | 51796-19-1 |
| | Specialties, US | castor oil, | g/cm3 | |
| | | Octadecanamide | | |

In a preferred embodiment the concentration of rheological control agent is in the range of 0 to 10% wt, e. g. of 1 to 7 or 3 to 6% wt. In particular, the concentration of rheological control agent may be 0, 0.5, 1, 1.5, 2, 2.5, 3, 4, 5, 6, 7, 8 or 9% wt and essentially depends on the physical properties of the biological control agent as well as those of the carrier liquid. In general, the concentration of rheological control agent in the formulation according to the invention may also depend on the biological control agent.

Antifoaming agents may be added to the present formulation in order to prevent foaming upon dilution with water. Suitable antifoaming agents are e.g. paraffinic oils, vegetable oils, silicone oils (e.g. Silcolapse 411, Silcolapse 454, Silcolapse 482 from Solvay; Silfoam SC1132, Silfoam SC132 from Wacker; Xiameter ACP-0100 from Dow) or aqueous silicone oil emulsions (e.g. SAG30, SAG 1572/Momentive, Silcolapse 426R, Silcolapse 432/Solvay; Silfar SE4/Wacker; Antifoam 8830/Harcros Chemicals). In a preferred embodiment the concentration of antifoaming agents is in the range of 0 to 0.5 wt, e. g. of 0.1 to 0.3% wt. In particular, the concentration of antifoaming agent may be 0, 0.1, 0.2, 0.3, 0.4 or 0.5% wt or any value in between.

Antioxidants may be added to the present formulation in order to prevent or slow down oxidative degradation processes. Suitable antioxidants are e.g. tert.-Butylhydroxyquinone (TBHQ), butylhydroxytoluol (BHT), butylhydroxyanisole (BHA), ascorbyl palmitate, tocopheryl acetate, ascorbyl stearate or the group of carotinoids (e.g. beta-carotin) or gallates (e.g. ethyl gallate, propyl gallate, octyl gallate, dodecyl gallate).

Dyes which may be used include inorganic pigments, examples being iron oxide, titanium oxide and Prussian Blue, and organic dyes, such as alizarin dyes, azo dyes and metal phthalocyanine dyes.

In a different aspect, the present invention relates to a liquid composition comprising the liquid preparation according to the invention.

The present invention also relates to a method for controlling phytopathogenic fungi, insects and/or nematodes in or on a plant, for enhancing growth of a plant or for improving plant health, including plant yield or root growth comprising applying an effective amount of the liquid preparation or the liquid composition according to the invention as described above to said plant or to a locus where plants are growing or intended to be grown.

The term “plant health” generally comprises various sorts of improvements of plants that are not connected to the control of pests or phytopathogens. For example, advantageous properties that may be mentioned are improved crop characteristics including: emergence, crop yield, protein content, oil content, starch content, more developed root system, improved root growth, improved root size maintenance, improved root effectiveness, improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination.

Improved plant health preferably refers to improved plant characteristics including: crop yield, more developed root system (improved root growth), improved root size maintenance, improved root effectiveness, tillering increase, increase in plant height, bigger leaf blade, less dead basal leaves, stronger tillers, greener leaf color, photosynthetic activity, more productive tillers, enhanced plant vigor, and increased plant stand.

With regard to the present invention, improved plant health preferably especially refers to improved plant properties selected from crop yield, more developed root system, improved root growth, improved root size maintenance, improved root effectiveness, tillering increase, and increase in plant height.

The effect of a composition according to the present invention on plant health as defined herein can be determined by comparing plants which are grown under the same environmental conditions, whereby a part of said plants is treated with a liquid preparation according to the present invention and another part of said plants is not treated with a liquid preparation according to the present invention. Instead, said other part is not treated at all or treated with a placebo (i.e., an application without a liquid preparation according to the invention such as an application without all active ingredients (i.e. without a biological control agent as described herein).

The liquid preparation according to the present invention may be applied in any desired manner, such as in the form of a seed coating, soil drench, and/or directly in-furrow and/or as a foliar spray and applied either pre-emergence, post-emergence or both. In other words, the liquid preparation can be applied to the seed, the plant or to harvested fruits and vegetables or to the soil wherein the plant is growing or wherein it is desired to grow (plant's locus of growth). Customary application methods include for example dipping, spraying, atomizing, irrigating, evaporating, dusting, fogging, broadcasting, foaming, painting, spreading-on, watering (drenching) and drip irrigating.

All plants and plant parts can be treated in accordance with the invention. Here, plants are to be understood to mean all plants and plant parts such as wanted and unwanted wild plants or crop plants (including naturally occurring crop plants),

Plants which can be treated in accordance with the invention include the following main crop plants: maize, soya bean, alfalfa, cotton, sunflower, Brassica oil seeds such as Brassica napus (e.g. canola, rapeseed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

Crop plants can be plants which can be obtained by conventional breeding and optimization methods or by biotechnological and genetic engineering methods or combinations of these methods, including the transgenic plants and including the plant varieties which can or cannot be protected by varietal property rights. Plants should be understood to mean all developmental stages, such as seeds, seedlings, young (immature) plants up to mature plants. Plant parts should be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Parts of plants also include harvested plants or harvested plant parts and vegetative and generative propagation material, for example seedlings, tubers, rhizomes, cuttings and seeds.

Treatment according to the invention of the plants and plant parts with the liquid preparation or the composition comprising said liquid preparation is carried out directly or by allowing the compounds to act on the surroundings, environment or storage space by the customary treatment methods, for example by immersion, spraying, evaporation, fogging, scattering, painting on, injection and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (genetically modified organisms), and parts thereof are treated. The term “parts” or “parts of plants” or “plant parts” has been explained above. The invention is used with particular preference to treat plants of the respective commercially customary cultivars or those that are in use. Plant cultivars are to be understood as meaning plants having new properties (“traits”) and which have been obtained by conventional breeding, by mutagenesis or by recombinant DNA techniques. They can be cultivars, varieties, bio- or genotypes.

Transgenic plants or plant cultivars (those obtained by genetic engineering) which are to be treated with preference in accordance with the invention include all plants which, through the genetic modification, received genetic material which imparts particular advantageous useful properties (“traits”) to these plants. Examples of such properties are better plant growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products. Further and particularly emphasized examples of such properties are increased resistance of the plants against animal and microbial pests, such as against insects, arachnids, nematodes, mites, slugs and snails owing, for example, to toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof), furthermore increased resistance of the plants against phytopathogenic fungi, bacteria and/or viruses owing, for example, to systemic acquired resistance (SAR), systemin, phytoalexins, elicitors and also resistance genes and correspondingly expressed proteins and toxins, and also increased tolerance of the plants to certain herbicidally active compounds, for example imidazolinones, sulphonylureas, glyphosate or phosphinothricin (for example the “PAT” gene). The genes which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails.

Furthermore, the present invention relates to the use of the liquid preparation or the liquid composition according to the invention as plant protection agent or for promoting plant vigor and/or plant health.

The following examples illustrate the present invention in a non-limiting fashion.

### Materials and Methods

### List of Carrier Fluids:

| Name | CAS-No. | Description | supplier | fluid type |
|---|---|---|---|---|
| Atlas G5002L | 99821-01-9 | Alcohol propoxylate-ethoxylate | Croda | c) |
| Alkamuls A | CAS 9004-96-0 | Polyethylene glycol Monooleate | Solvay | c) |
| Ariatone TV | CAS 54846-79-6 | Sorbitol-Heptaoleate, 40EO | Croda | c) |
| Atplus 245 | | Alcohol ethoxylate | Croda | c) |
| Berol 050 | 68551-12-2 | Linear ethoxylated alcohol C12- | Akzo-Nobel | c) |
| | | C16, 3EO, HLB 8 | | |
| Berol 260 | | ethoxylated alcohol C9-C11 4EO, | Akzo-Nobel | c) |
| | | HLB 10.5 | | |
| Butylcarbitol | 112-34-5 | diethylenglycol monobutylether | Dow | — |
| Butylcellosolve | 111-76-2 | Ethylenglycolmonobutylether | Dow | — |
| Carbitol | CAS 111-90-0 | Diethylenglycolmonoethyl ether | Dow | — |
| Dipropylene glycol | 110-98-5 | | ABCR | c) |
| Dipropylene glycol | 111109-77-4 | Dipropylene glycol dimethyl ether | Sigma-Aldrich | c) |
| DME | | | | |
| Dipropylene glycol | 88917-22-0 | | Sigma-Aldrich | c) |
| methyl ether acetate | | | | |
| Dowanol DPM | | Dipropylene Glycol monomethyl | Dow | c) |
| | | ether | | |
| Dowanol TPM | 25498-49-1 | Tripropylene Glycol monomethyl | Dow | c) |
| | | ether | | |
| Ecosurf EH3 | 64366-70-7 | Triethylenglycol-monooctylether | Dow | c) |
| Etocas 10 | 61791-12-6 | Ethoxylated Castor oil 10EO, HLB | Croda | a) |
| | | 6.6 | | |
| Hexylcellosolve | 112-25-4 | Ethylenglycolmonohexylester | Dow | — |
| Leofat OC0503M | | Fatty acid, Propoxylated- | Lion Chemical | c) |
| | | ethoxylated, end-capped Methyl | | |
| Lucramul CO08 | 61791-12-6 | Castor oil ethoxylate 8EO | Levaco | a) |
| Lucramul HOT 5902 | 64366-70-7 | Alcohol propoxylate-ethoxylate | Levaco | c) |
| Lucramul L03 | 68213-23-0 | C12-C18 ethoxyated alcohols, | Levaco | c) |
| | | 3EO | | |
| Lucramul L05 | 68213-23-0 | C12-C18 ethoxyated alcohols, 5EO | Levaco | c) |
| Lutensol AO3 | 157627-86-6 | C13-15-branched and linear | BASF | c) |
| | | ethoxylated alcohols, 3EO | | |
| Lutensol AO7 | 157627-86-7 | C13-15-branched and linear | BASF | c) |
| | | ethoxylated alcohols, 7EO | | |
| Methoxytriglycol | 112-35-6 | Triethylenglycol monomethyl | Sigma-Aldrich | — |
| | | ether | | |
| n-Butyldiglycolacetat | 112-15-2 | 2-(2-Ethoxyethoxy)ethyl acetate; | Sigma-Aldrich | c) |
| | | Diethylene glycol monoethyl ether | | |
| | | acetate | | |
| Pluriol E300 | 25322-68-3 | Polyethylenglycol- 300 | BASF | c) |
| Propylcellosolve | 2807-30-9 | Ethylenglycolmonopropylether | Sigma-Aldrich | |
| Propylenglycol | 623-84-7 | | Sigma-Aldrich | c) |
| Diacetat | | | | |
| Radiasurf 7402 | | Polyethyleneglycol-200 | Oleon | c) |
| | | monooleate | | |
| Radiasurf 7403 | 9004-96-0 | Polyethyleneglycol-400 | Oleon | c) |
| | | monooleate | | |
| Radiasurf 7423 | 9004-81-3 | Polyethyleneglycol-400 | Oleon | c) |
| | | monolaurate | | |
| Radiasurf 7442 | 9005-07-6 | Polyethyleneglycol-400 dioleate | Oleon | c) |
| Synperonic PE/L 44 | | Block-Copolymer, 40% EO, | Croda | b) |
| | | MW ~2200 g/mol | | |
| Synperonic PE/L 62 | | Block-Copolymer, 20% EO, | Croda | b) |
| | | MW ~2500 g/mol | | |
| Synperonic PE/L 64 | | Block-Copolymer, 40% EO, | Croda | b) |
| | | MW ~2900 g/mol | | |
| Triethylenglycol- | 143-22-6 | Triethylenglycol-monobutylether | Aldrich | c) |
| monobutylether | | | | |
| Tetraglyme | 143-24-8 | Tetraethylenglycol diether | Sigma-Aldrich | c) |
| Tween 20 | 9005-64-5 | ethoxylated sorbitol monolaurate, | Croda | c) |
| | | 20EO | | |
| Tween 80 | 9005-65-6 | ethoxylated sorbitol monooleate, | Croda | c) |
| | | 20EO | | |
| Tween 85 | 9005-70-3 | ethoxylated sorbitol trioleate, | Croda | c) |
| | | 20EO | | |

### EXAMPLE I (P. LILACINUM)

3 g of P. lilacinum strain 251 pure spore powder were transferred into a formulation vessel (IKA Type DT-20 mixing vessel with dispersion tool for Ultra Turrax) using a sterile spoon. 12 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 2504 of each sample are transferred into 50 mL falcon tubes. The tubes were filled up to 25 g using a sterile aqueous solution containing 2% Tween 80 and homogenized by vortexing to achieve the first dilution step (1:100 dilution). This dilution is used for further dilution and spotting on agar.

For evaluation of spore germination rate prepare a 1:30000 dilution based on the 1:100 dilution achieved by multiple automated dilution (pipetting robot, 96 well plate). Afterwards 12×12 cm agar plates are taken and spotted with 10 times 54 of each sample using an automated 12-Channel pipet. Wait until liquid is soaked up by agar and transfer agar plate to an incubator and incubate at 25° C. for 17 hours. Open the plate and place it under the microscope. Randomly choose one area per spot and record the number of germinated and non-germinated spores that are within the designated field. At least 200 spores per sample need to be evaluated. If needed count more than one field per spot.

The results of spore viabilities are given in table I.

TABLE I

| | | spore viability [%] | | | | | | | |
|---|---|---|---|---|---|---|---|---|---|
| | | | after | after | after | after | after | after | after |
| | | at | 2 w | 1 m | 5 w | 6 w | 2 m | 3 m | 7 m |
| No | Liquid | day 1 | (12-15 d) | (27-28 d) | (35 d) | (40 d) | (51-55 d) | (87-92 d) | (210 d) |
| 1 | Atlas G5002L | * | 97.4 | 96.0 | | | 90.7 | | |
| 2 | Atplus 245 | 64.3 | 56.6 | 58.1 | | | 44.1 | | |
| 3 | Berol 050 | 96.1 | 89.1 | 92.7 | | | 66.9 | | 59.1 |
| 4 | Berol 260 | 79.0 | 83.7 | 83.9 | | | 73.7 | | |
| 5 | Butylcarbitol# | 92.7 | 62.1 | 10.8 | | | 3.2 | | 0.6 |
| 6 | Butylcellosolve# | 68.1 | | | 35.8 | | | 22.4 | |
| 7 | Dipropylene glycol | 95.0 | | | 94.5 | | | 85.4 | |
| 8 | Dowanol DPM | 91.0 | 95.3 | 93.3 | | | 74.7 | | |
| 9 | Dowanol DPMA | 99.1 | | | 93.0 | | | 35.7 | |
| 10 | Dowanol PGDA | 98.8 | | | 98.2 | | | 88.4 | |
| 11 | Dowanol TPM | 85.4 | 94.3 | 95.6 | | | 84.5 | | |
| 12 | Ecosurf EH3 | 93.1 | | 80.1 | | | | 64.4 | |
| 13 | Etocas 10 | * | 97.0 | 97.2 | | | 97.8 | | |
| 14 | Hexylcellosolve# | 79.5 | | | 27.4 | | | 6.0 | |
| 15 | Leofat OC0503M | 96.2 | | | 96.0 | | | 93.5 | |
| 16 | Lucramul CO08 | 98.7 | | | | 91.9 | | 86.3 | |
| 17 | Lucramul HOT 5902 | 86.5 | | | 86.0 | | | 66.2 | |
| 18 | Lucramul L03 | 99.0 | | | | 90.1 | | 86.3 | |
| 19 | Lucramul L05 | 97.5 | | | | 89.2 | | 71.2 | |
| 20 | Methoxytriglycol# | 83.3 | | | 55.3 | | | 19.9 | |
| 21 | n-Butyldiglycolacetat | 93.2 | | | 89.3 | | | 82.7 | |
| 22 | Proglyde DMM | 98.8 | | | 96.0 | | | 75.4 | |
| 23 | Propylcellosolve# | 76.2 | | | 8.1 | | | 0.6 | |
| 24 | Radiasurf 7402 | 96.7 | 83.6 | 64.8 | | | 34.7 | | |
| 25 | Radiasurf 7403 | 98.6 | 98.3 | 98.9 | | | 93.7 | | 78.3 |
| 26 | Radiasurf 7423 | 90.8 | 91.4 | 93.8 | | | 79.7 | | 36.9 |
| 27 | Radiasurf 7442 | 98.7 | 96.5 | 98.2 | | | 96.8 | | 88.3 |
| 28 | Synperonic PE/L 44 | 94.5 | | | 94.2 | | | 53.4 | |
| 29 | Synperonic PE/L 62 | 97.1 | 96.9 | 95.3 | | | 91.6 | | 61.4 |
| 30 | Synperonic PE/L 64 | 96.5 | | | 92.3 | | | 64.8 | |
| 31 | Triethylenglycol | 77.5 | | 57.5 | | | | 50.8 | |
| | monobutylether | | | | | | | | |
| 32 | Tetraglyme | 97.2 | 97.6 | 94.8 | | | 93.2 | | 83.5 |
| 33 | Breakthru S240$ | 90.5 | 91.8 | 85.8 | | | 76.8 | 37.3 | 7.4 |

* Sample could not be evaluated for technical reasons;
$control, average values out of 6 trials;
#not according to the invention.

### Discussion:

From the results depicted in Table I it becomes evident that not every fluid is suitable to provide good spore viabilities after storage. Spore viability directly after manufacturing of the samples (day 1) is generally high and in most cases at or above 80%, in many cases even above 90%. Certain fluids that do not belong to the scope of this invention exhibit a steep decline in spore viability even at day 1 after preparation of the samples and even more after storage under given conditions (Table I, entries 5, 6, 14, 20, 23). BreakThru 5240 has been previously described as a superior fluid to host fungals spores. Under the given test conditions BreakThru 5240 (Table I, entry 33) provides ˜77% spore viability after 2 m of storage and ˜7% after 7 m of storage. Among the examples according to the invention are selected fluids that exhibit a spore viability of approx. 53% or greater after storage for 2 or 3 months, respectively. In many cases, spore viabilities of approx. 80% or greater were detected (Table I, entries 1, 7, 10, 11, 13, 15, 16, 18, 21, 26, 29). For selected fluids exceptional spore viability was found even after storage for 7 months at 30° C. (Table I, entries 25, 27, 32).

### EXAMPLE II (ISARIA FUMOSOROSEA)

Method 1: 1.5 g of Isaria fumosorosea pure spore powder were transferred into a formulation vessel (IKA Type DT-20 mixing vessel with dispersion tool for Ultra Turrax) using a sterile spoon. 13.5 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 2504 of each sample are transferred into 50 mL falcon tubes. The tubes were filled up to 25 g using a sterile aqueous solution containing 2% Tween 80 and homogenized by vortexing to achieve the first dilution step (1:100 dilution). This dilution is used for further dilution and spotting on agar.

For evaluation of spore germination rate a 1:15000 dilution based on the 1:100 dilution achieved by multiple automated dilution (pipetting robot, 96 well plate) was prepared. Afterwards 12×12 cm agar plates were taken and spotted with 10 times 5 μL of each sample using an automated 12-Channel pipet. After all liquid is soaked up by agar the agar plates were incubated at 23° C. for 16 hours.

Method 2: 0.5 g of Isaria fumosoresea pure spore powder were transferred into an Erlenmeyer flask using a sterile spoon. 24.5 mL of fluid were dispersed using Ultra-Turrax (IKA; Type T 25 D) for 1 min at 3,000 rpm. After this, 2.0 mL were transferred in 20 sample bottles (Wheaton Serum vial, Type I) leaving little headspace and closed tight using crimpneck caps (Macherey—Nagel type N 13). Afterwards all sample bottles were transferred to an incubator set at 30° C. and stored for a given time.

In regular intervals a sample was retrieved from the storage location and analyzed for spore viability. For this purpose, the original samples were thoroughly homogenized. Aliquots of 0.5 g of each sample were transferred into 100 mL-Erlenmeyer flask. The flasks were filled up to 50 g using a sterile aqueous solution containing 0.1% Break Thru® 5240 (Evonik, Industries) and homogenized on a magnetic stirrer (Thermo Fisher Scientific: Cimarec™) at least for 15 min with 750 rpm to achieve the first dilution step (1:100 dilution). This dilution was used for further dilution.

Not all samples mixed well or mixed at all in 0.1% Break Thru 5240. For these samples, 500 μL Neo-wett (Kwizda Agro GmbH) and/or a small amount (knife tip) Metaupon®-OMT (LEUNA Tenside GmbH) were also added to the aqueous solution.

After homogenization 1 mL were transferred into a 1.5 mL tube and were centrifuged for 15 min at 14,000 rpm (Thermo Fisher Scientific, Type Megafuge 8R). The supernatant (=upper phase) was discarded by using a pipette. The tubes were filled up to 1 mL using a sterile aqueous solution containing 0.1% Neo-wett and homogenized by vortexing.

To assess fungal viability, a method based on flow cytometry was used.

The results of spore viabilities are given in table II.

TABLE II

| | | spore viability [%] | | | | |
|---|---|---|---|---|---|---|
| | | at | after 2 w | after 1 m | after 7 m | |
| No | Liquid | day 1 | (~14 d) | (27 d) | (210 d) | Method |
| 1 | Butylcarbitol^{#} | 19.1 | | 0.5 | 2.4 | 1 |
| 2 | Carbitol^{#} | 78.0 | 13.7 | 12.0 | | 2 |
| 3 | Alkamuls A | 94.4 | 93.0 | 90.7 | | 2 |
| 4 | Ariatone TV | 97.0 | 71.7 | 66.7 | | 2 |
| 5 | Dowanol DPMA | 87.7 | | 63.6 | 31.4 | 1 |
| 6 | Dowanol TPM | 88.0 | | 65.4 | 52.6 | 1 |
| 6a | Dowanol TPM | 82.0 | | 59.0 | | 2 |
| 7 | Etocas 10 | 93.7 | | 82.9 | 75.1 | 1 |
| 7a | Etocas 10 | 93.8 | 92.0 | 88.8 | | 2 |
| 8 | Lucramul HOT 5902 | 93.0 | | 32.0 | | 2 |
| 9 | Lutensol AO3 | 95.8 | 93.6 | 84.6 | | 2 |
| 10 | Lutensol AO7 | 94.4 | 92.8 | 82.9 | | 2 |
| 11 | Pluriol E300 | 96.0 | | 87.0 | 45.0* | 2 |
| 12 | Propylenglycol Diacetat | 97.0 | | 53.0 | | 2 |
| 13 | Radiasurf 7402 | 92.5 | | 11.6 | 1.1 | 1 |
| 13a | Radiasurf 7402 | 89.9 | 20.5 | 15.8 | | 2 |
| 14 | Radiasurf 7403 | 94.0 | | 76.2 | 79.3 | 1 |
| 14a | Radiasurf 7403 | 89.0 | 86.0 | 92.0 | | 2 |
| 15 | Radiasurf 7423 | 86.7 | 58.0 | 42.3 | | 2 |
| 16 | Radiasurf 7442 | 89.4 | | 72.1 | 58.1 | 1 |
| 16a | Radiasurf 7442 | 87.4 | 69.6 | 66.3 | | 2 |
| 17 | Tween 20 | 98.6 | 98.9 (98.1**) | | | 2 |
| 18 | Tween 80 | 96.2 | 76.4 | 72.0 | | 2 |
| 19 | Tween 85 | 98.9 | | 98.0 | 96.1*** | 2 |
| 20 | Synperonic PE/L 62 | 91.6 | | 72.8 | 74.9 | 1 |
| 21 | Breakthru S240^{$} | 90.9 | | 78.7 | 69.6 | 1 |

spore viability of I. Fumosorosea after storage;
^{#}not according to the invention;
^{$}control;
*after 3 months;
**after storage for 2 weeks at 40° C.,
***after 6 months

### Discussion:

Spore viability directly after manufacturing of the samples (day 1) is generally high and in most cases at or above 90% with the exception of Butylcarbitol and Carbitol (Table II, entry 1, 2) which were used as negative standard (i.e. not according to the invention). As demonstrated with a few examples (Table 2, entries 6/6a, 7/7a, 13/13a, 14/14a, 16/16a) both methods for determination of spore viability provide comparable results. Among the examples according to the invention are selected fluids that exhibit a spore viability of approx. 60% or greater after storage for 1 month (Table II, entries 3-7, 9-12, 14, 16,-1-20) or approx. 50% or greater after storage for 7 m at 30° C. (Table 2 entries 6, 7, 14, 16, 19, 20).

### EXAMPLE III (BEAUVERIA BASSIANA)

1.5 g of Beauveria Bassiana pure spore powder were transferred into a formulation vessel (IKA Type DT-20 mixing vessel with dispersion tool for Ultra Turrax) using a sterile spoon. 13.5 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 2504 of each sample are transferred into 50 mL falcon tubes. The tubes were filled up to 25 g using a sterile aqueous solution containing 2% Tween 80 and homogenized by vortexing to achieve the first dilution step (1:100 dilution). This dilution is used for further dilution and spotting on agar.

For evaluation of spore germination rate prepare a 1:15000 dilution based on the 1:100 dilution achieved by multiple automated dilution (pipetting robot, 96 well plate). Afterwards 12×12 cm agar plates are taken and spotted with 10 times 54 of each sample using an automated 12-Channel pipet. Wait until liquid is soaked up by agar and transfer agar plate to an incubator and incubate at 20° C. for 17 hours. Open the plate and place it under the microscope. Randomly choose one area per spot and record the number of germinated and non-germinated spores that are within the designated field. At least 200 spores per sample need to be evaluated. If needed count more than one field per spot. The results of spore viabilities are given in Table III.

TABLE III

| | | spore viability [%] | | | |
|---|---|---|---|---|---|
| | | at day | after 2 w | after 3 w | after 5 w |
| No | Liquid | 1 | (14 d) | (21 d) | (35 d) |
| 1 | Atlas G5002L | 91.9 | | 72.4 | |
| 2 | Berol 050 | 88.7 | | 78.7 | |
| 3 | Berol 260 | 86.0 | | 72.4 | |
| 4 | Butylcarbitol | 53.3 | | | 0.8 |
| 5 | Dipropylene glycol | 64.0 | 52.8 | | 51.7 |
| 6 | Proglyde DMM | 88.4 | 48.0 | | 21.8 |
| 7 | Dowanol DPM | 83.9 | 61.0 | | 36.6 |
| 8 | Dowanol TPM | 63.9 | 19.0 | | 15.5 |
| 9 | Etocas 10 | 90.6 | | 81.5 | |
| 10 | Leofat OC0503M | 88.1 | | 82.5 | |
| 11 | Lucramul HOT 5902 | 80.1 | | 71.1 | |
| 12 | Methoxytriglycol | 79.7 | 12.3 | | 1.5 |
| 13 | Dowanol PGDA | 90.6 | | 51.6 | |
| 14 | Radiasurf 7403 | 81.4 | 77.3 | | 72.3 |
| 15 | Radiasurf 7442 | 85.9 | | 33.2 | |
| 16 | Synperonic PE/L 62 | 89.0 | | 66.1 | |
| 17 | Synperonic PE/L 64 | 87.8 | | 70.0 | |

# not according to the invention

### Discussion:

Spore viability directly after manufacturing of the samples (day 1) is generally high and in most cases at or above 80%, in many cases even above 90%. Fluids that do not fall within the scope of this invention exhibit a steep decline in spore viability after storage under given conditions (Table III, entries 4, 12). Among the examples according to the invention are selected fluids that exhibit a spore viability of approx. 50% or greater after storage for 3w or longer at 30° C. (Table III, entries 1, 2, 3, 5, 9, 10, 14, 17)

### EXAMPLE IV: PENICILLIUM BILAII

1.5 g of Penicillium bilaii (ATCC 20851) pure spore powder were transferred into a formulation vessel (IKA Type DT-20 mixing vessel with dispersion tool for Ultra Turrax) using a sterile spoon. 13.5 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 2504 of each sample are transferred into 50 mL falcon tubes. The tubes were filled up to 25 g using a sterile aqueous solution containing 2% Tween 80 and homogenized by vortexing to achieve the first dilution step (1:100 dilution). This dilution is used for further dilution and spotting on agar.

For evaluation of spore germination rate prepare a 1:15000 dilution based on the 1:100 dilution achieved by multiple automated dilution (pipetting robot, 96 well plate). Afterwards 12×12 cm agar plates are taken and spotted with 10 times 54 of each sample using an automated 12-Channel pipet. Wait until liquid is soaked up by agar and transfer agar plate to an incubator and incubate at 20° C. for 17 hours. Open the plate and place it under the microscope. Randomly choose one area per spot and record the number of germinated and non-germinated spores that are within the designated field. At least 200 spores per sample need to be evaluated. If needed count more than one field per spot. The results of spore viabilities are given in table IV.

TABLE IV

| | | spore viability [%] | | |
|---|---|---|---|---|
| | | initial | 6 w@30° C. | 3 m@30° C. |
| No | Liquid | (1-2 d) | (41-43 d) | (83-85 d) |
| 1 | Atlas G5002L | 95.1 | 76.3 | 55.8 |
| 2 | Berol 050 | 65.7 | 50.9 | 37.7 |
| 3 | Berol 260 | 51.4 | 27.2 | 20 |
| 4 | Breakthru S240# | 53.1 | 27.6 | 19.6 |
| 5 | Dipropylene glycol | 83.8 | 44.1 | 29.5 |
| 6 | Dipropylene glycol DME | 54.6 | 29.6 | 10.5 |
| 7 | Dowanol PGDA | 93.6 | 69.3 | 36.4 |
| 8 | Dowanol TPM | 67.2 | 7.6 | 2.8 |
| 9 | Etocas 10 | 97.2 | 78.8 | 65.9 |
| 10 | Leofat OC0503M | 93.4 | 73.3 | 64.1 |
| 11 | Lucramul HOT 5902 | 45.8 | 27.8 | 20 |
| 12 | Methoxytriglycol | 74.3 | 43.1 | 30.3 |
| 13 | Radiasurf 7355 | * | 78.9 | 40.4 |
| 14 | Radiasurf 7403 | 78.1 | 66.8 | 61.8 |
| 15 | Radiasurf 7442 | 96.7 | 91 | 76.5 |
| 16 | Synperonic PE/L 62 | 98.4 | 84.1 | 61.4 |
| 17 | Synperonic PE/L 64 | 83.5 | 68 | 51.3 |
| 18 | Tween 85 | 99.0 | | 92.0$ |

* Sample could not be evaluated for technical reasons;
#control;
$after 2 months

### Discussion:

Spore viability directly after manufacturing of the samples (day 1) is quite variable; in most cases the viability is at or above 50%, in selected cases even above 90%. Among the examples according to the invention are selected fluids that exhibit a spore viability of approx. 50% or greater after storage for approx. 3 months at 30° C. (Table IV, entries 1, 10,11,15-17). In many cases the spore viability in selected fluids is above that of Break-Thru 5240 used as control after storage for approx. 3 months at 30° C., i.e. above approx. 20%. Some fluids provide inferior spore viability under conditions given here.

1. A liquid preparation essentially free of water comprising at least one ethoxylated and/or propoxylated organic liquid which is selected from the group consisting of
a) ethoxylated fatty acid triglycerides with 3-10 ethylene oxide units wherein the fatty acid triglycerides are selected from the group consisting of castor oil and plant oils;
b) a block copolymer of the general formula
H—O—[CH2-CH2-O-]a1-[CH2-CH(CH3)-O]b-[CH2-CH2-O-]a2-H
where a1 and a2 have independently from each other an average value of between 1 and 20 and b has an average value of between 15 and 35;
c) a polymer of the general formula
X—O—[CH2-CH(CH3)-O]m-[CH2-CH2-O-]n-Y
where X and Y are independently selected from
hydrogen
branched or linear alkyl with 1-24 carbon atoms, and
branched or linear carbonyl with 2-24 carbon atoms, saturated or partially unsaturated, optionally carrying hydroxyl functionality;
where m is an average number between 0 and 10;
where n is an average number between 0 and 40,
where m+n is not zero
or a mixture of any one of a) to c);
and fungal spores.

2. The liquid preparation according to claim 1, wherein said ethoxylated fatty acid triglycerides according to a) are plant oils selected from the group consisting of sunflower oil, rapeseed oil, soybean oil, corn oil, coconut oil, and palm oil.

3. The liquid preparation according to claim 1, wherein said ethoxylated fatty acid triglycerides according to a) are castor oils.

4. The liquid preparation according to claim 1, wherein said ethoxylated and propoxylated organic liquid according to b) is selected from the group consisting of Block-Copolymers with an average mol wt. of between about 1000 and about 3000 g/mol and where a1 and a2 have independently from each other an average value of between 1 and 20 and b has an average value of between 15 and 35.

5. The liquid preparation according to claim 1, wherein said ethoxylated and propoxylated organic liquid according to b) is selected from the group consisting of Block-Copolymers with an average mol wt. of between about 1500 and about 3000 g/mol and where a1 and a2 have independently from each other an average value of between 10 and 15 and b has an average value of between 20 and 30.

6. The liquid preparation according to claim 1, wherein said ethoxylated and propoxylated organic liquid according to b) is selected from the group consisting of Block-Copolymers with an average molecular weight between about 2000 and about 3000 g/mol and where a1 and a2 have independently from each other an average value of between 3 and 16 and b has an average value of between 25 and 35; and Block-Copolymers with an average molecular weight between about 1400 and about 2200 g/mol and where a1 and a2 have independently from each other an average value of between 2 and 12 and b has an average value of between 15 and 25.

7. The liquid preparation according to claim 1, wherein in the polymer of c), X is branched or linear alkyl with 1-18 carbon atoms or branched or linear carbonyl with 2-18 carbon atoms, saturated or partially unsaturated, optionally carrying hydroxyl functionality and Y is hydrogen or branched or linear alkyl with 1-6 carbon atoms or branched or linear carbonyl with 2-6 carbon atoms, saturated or partially unsaturated, optionally carrying hydroxyl functionality, or
wherein in the polymer of c), X is branched or linear alkyl with 1-6 carbon atoms or branched or linear carbonyl with 1-6 carbon atoms, saturated or partially unsaturated, optionally carrying hydroxyl functionality and y is branched or linear alkyl with 1-18 carbon atoms or branched or linear carbonyl with 2-18 carbon atoms, saturated or partially unsaturated, optionally carrying hydroxyl functionality.

8. (canceled)

9. The liquid preparation according to claim 1, wherein in the polymer of c) m+n is between 1 and 30.

10-11. (canceled)

12. The liquid preparation according to claim 1, wherein, in the polymer of c), if m equals zero the molecular weight (MW) of said at least one ethoxylated organic liquid is greater than or equal to 190 mass units.

13. The liquid preparation according to claim 12, where if m equals zero the molecular weight (MW) of said at least one ethoxylated organic liquid is greater than or equal to 205 mass units.

14. The liquid preparation according to claim 1, wherein said ethoxylated and/or propoxylated organic liquid according to c) is selected from the group consisting of polyethylene oxide, ethoxylated alcohols, mono-/polyethylene oxide diethers, mono-/polyethylene oxide ether-ester, ethoxylated carboxylic acids, mono-/polyethylene oxide di-esters, polypropylene oxide, propoxylated alcohols, mono-/polypropylene oxide diethers, mono-/polypropylene oxide ether-ester, propoxylated carboxylic acids, mono-/polypropylene oxide di-esters, alcohol propoxylate-ethoxylates, carboxylic acid propoxylate-ethoxylates and carboxylic acid propoxylate-ethoxylate ethers.

15. The liquid preparation according to claim 1, wherein said ethoxylated and/or propoxylated organic liquid is present in an amount of at least 40 wt.-%, preferably at least 50 wt.-%.

16. The liquid preparation according to claim 1, which is water-miscible.

17-19. (canceled)

20. The liquid preparation according to claim 1, wherein said fungal species is selected from the group consisting of Isaria fumosorosea, Penicillium bilaii, Metarhizium anisopliae, Purpureocillium lilacinum, Coniothyrium minitans, Beauveria bassiana and Clonostachys rosea.

21. The liquid preparation according to claim 1, further comprising at least one substance selected from the group of surfactants, rheology modifiers, antifoaming agents, antioxidants and dyes.

22. The liquid preparation according to claim 21, wherein said rheology modifier is selected from the group consisting of fumed (hydrophobic/hydrophilic) or precipitated silica, silica of natural origin, attapulgite-based rheology modifiers, organo-modified clays, and mixtures thereof.

23. The liquid preparation according to claim 22, wherein said rheology modifier is fumed silica.

24. The liquid preparation according to any one of the preceding claims, comprising 0.1 to 40 wt.-% of fungal spores, up to 99.9% of at least one ethoxylated and/or propoxylated organic liquid according to any one of claims 1 to 16 and 0 to 10 wt.-% of at least one surfactant and/or rheology modifier.

25. A liquid composition comprising the liquid preparation according to claim 1.

26. Method for controlling phytopathogenic fungi, insects and/or nematodes in or on a plant, for enhancing growth of a plant or for increasing plant yield or root health comprising applying an effective amount of the liquid preparation or the liquid composition according to any of the preceding claims to said plant or to a locus where plants are growing or intended to be grown.

27. (canceled)
